(19) United States
(12) Patent Application Publication
(10) Pub. No.: US 2015/0127628 A1
(43) Pub. Date: May 7, 2015

(54) Method and System for Display Dynamic & Accessible Actions with Unique Identifiers and Activities

(71) Applicant: Yogesh Chunilal Rathod, Mumbai (IN)

(72) Inventor: Yogesh Chunilal Rathod, Mumbai (IN)

(73) Assignee: ONEPATONT SOFTWARE LIMITED, Mumbai, Maharashtra (IN)

(21) Appl. No.: 14/394,546

(22) PCT Filed: Apr. 27, 2012
(86) PCT No.: PCT/IN12/00316

§ 371 Date: Jan. 7, 2015

(30) Foreign Application Priority Data
Apr. 16, 2012 (IN) 1227/MUM/2012

(51) Int. Cl. G06F 17/30; H04W 8/26

(52) U.S. Cl. CPC G06F 17/30876; H04W 8/26; G06F 17/30867; G06F 17/30038
USPC 707/710

(57) ABSTRACT

A methods, systems and apparatus for enable dynamic actions on unique identifier including mobile phone number(s) and activities are described. A method includes dynamically, manually or automatically attach, associate, provide, present and access on demand, integrated, unified, in-mobile, inline, loosely coupled, user friendly, personalize, customized, all-in-one, unified, contextual, interconnected, abbreviated, portable, dynamic and accessible action links with one or more unique identifier including mobile phone number(s) and with activities for enable users and connected users of user to create multiple customized communication channels, social networks, facilitates in participating with activities of connected users, and providing real time communication, collaboration, interactions, dynamic actions, transactions, groupings, workflow, publishing, and sharing platform.

### COPYRIGHTS INFORMATION

A portion of the disclosure of this patent document contains material that is subject to copyright protection. The copyright owner has no objection to the facsimile reproduction by anyone of the patent document or the patent disclosure, as it appears in the Patent and Trademark Office patent file, but otherwise reserves all copyright rights whatsoever. The applicant acknowledges the respective rights of various Intellectual property owners.

### FIELD OF INVENTION

The present invention relates generally to creating social graph based on unique identifiers including mobile phone numbers associate with user and connected users of user's device(s) and enable to determine, attach, auto associate, apply privacy settings, share, present and access dynamic & accessible action links associate with unique identifier(s) and user defined, selected, auto presented, prospective and current activities.

Generally user can click on mobile phone number and make call with other person. Generally Mobile device or application provides default options or user actions on each mobile, phone number or selected mobile phone number from list of mobile contacts or list of incoming phone numbers including Create Message, Voice Call, Video Call, Delete, Use Number (Edit, Copy), Save to Contacts (Create New, Update Existing), Record Phone, Write Notes and other general or predefined actions on each mobile number. User can not dynamically attach, associate, and access each mobile phone number specific dynamic user actions enabling user to access plurality of communication channels, social networking, communications, participations, activities specific dynamic actions.

Present invention creates social graphs based on mobile phone number of user and connected users of user and enables attaching, associating and accessing of dynamic & accessible actions on each unique mobile phone number of user and connected users of user, which enables dynamic and customize social networks, groups, workspace, communication, collaboration, e-commerce, viral marketing, advertisements, interactions, sharing, participating activities of other users, creating new connections.

Currently mobile phone users mainly use phone numbers from contacts to call selected mobile phones, send messages and chat with other people. Present invention utilize unique and trusted mobile phone number of user and connected or related or matched users of user to associate, attach, create, provide, manage, facilitate multiple expanded logical and dynamic communication channels and activities specific dynamic actions. By using present invention user can select or identify particular mobile phone number or activities and can access particular mobile phone or activity associated or attached dynamic and accessible actions which enables fulfillment of activities, transactions, workflow, tasks and user can dynamically access plurality of dynamic features, functions, social networks, groups, workspace for communication, collaboration, sharing, participate with other users and doing plurality of activities based on accessing dynamic actions.

Presently user has to register with different web sites for different purposes including search engines, e-commerce web sites, social networking web sites, messaging and communication web sites and applications. Conventionally, a user can search, register web sites, subscribe services, install applications, share contents, and make payments by using plurality of sources for wide different varieties of user's requirements and activities. Typically these sources are disparate and disorganized. In other words, the user must spend time researching, searching, registering, accessing, and identifying different sources that are not present in consolidated, coherent, unified and integrated manner. Often many of the sources are not relevant to user. What is needed is enables to attaching, associating and accessing of dynamic & accessible actions on each unique mobile phone number of user and connected users of user and user's activities in unified and integrated manner for solving users on demand wide varieties of requirements.

Therefore, it is with respect to these considerations and others that the present invention has been made.

No prior art provides on demand, customize, contextual, dynamic, unified and integrated environment for communication, collaboration, transaction, participation, sharing, providing response, with mobile phone number of user and connected users of user. User does not have to install plurality of applications, subscribe services, register with different applications, web sites and services, and maintain different profiles for different web sites & apps, searching content and media data from plurality of different sources. By using present invention user can access plurality of applications, services, communication channels, activities specific dynamic actions, objects, connected or connectable nodes of network without departing from present network and user can share user data, application data, and profile with plurality of apps, services and users based on privacy settings.

The principal object of the present invention is to enable providers to develop, create, register, verify, maintain, store, upload, update, upgrades, process, manage, provide dynamic & accessible action links and associate referred applications, services, objects, controls, multimedia data, user actions, interface, networks, groups, databases, attachments, lists, connections, privacy settings, preferences, metadata, connectable nodes of the network(s) and verify, validate, register, store to Dynamic & Accessible Actions Server(s) or central server unit for making them searchable for network users and enable users to search, match, select, purchase, download, subscribe, register, attach, associate, update, upgrades, rank and access dynamic & accessible action links on each unique identifier and user or auto defined, created, generated, auto recognized & presented activity including mobile phone number and dynamic activities of user and connected users of user. User is enabling to apply privacy settings to each said unique identifier associate dynamic & accessible links for allowing selected users including connected or related or matched or suggested or subscribers or users of network(s) to access said dynamic & accessible link(s). Dynamic & Accessible Actions Server(s) or central server unit dynamically updates and presents said each dynamic & accessible action link of each user to selected, connected, related users of user based on said privacy settings of sender or source and/or receiving users, wherein accessing of said dynamically presented dynamic & accessible action links enables dynamic, customize, contextual, unified, in-phone number, integrated, trusted, verified, secure, on demand & accessible social networks, groups, workflow, workspace, communication, collaboration, making new connections, e-commerce, viral marketing, advertisements, interactions, transactions, user actions, sharing, and participation of activities between or among user, connected users of users, providers and dynamic & accessible link(s). Dynamic & Accessible Actions Server(s) or central server unit and providers stores information about interactions between or among user, connected users of users, providers and dynamic & accessible link(s).

Another significant objective of the present invention is to facilitate users to dynamically or manually or auto create, manage, identify user's and connected user's activities or actions and dynamically or manually or auto create, search, match, select, identify, detect, sense, determine, attach, detach, share, synchronize, clone, sent, receive, apply privacy settings, manage, present said one or more activities specific one or more associate dynamic & accessible action link(s) which enables user's and connected or related users of user to fulfill, workflow, communicate, collaborate, share, transact, interact, participate with said activities and associate users.

Another significant objective of the present invention is to creating and updating mobile social graphs based on user's and connected users of user's mobile device associate unique identifiers including mobile phone numbers. Each node is unique identifiers and activities and central server unit stores information about relationship between or among nodes including user connection information, user actions, activities, interactions, transactions, sharing, communication, collaboration, sharing, participation, location, interest, likes, dislikes, behavior, status, events and plurality of other relationships.

Another significant objective of the present invention is to dynamically present advertisements and associate dynamic & accessible action links to user and connected or related users of user based on matching targeting criteria of advertisements, profile of advertised products and services, associate location profile, sensor or device profile, place profile (e.g. shop profile data) with user's and/or connected users of user's one or more defined, created, selected, matched, current, prospective, auto identified or detected or sensed or recognize, shared, suggested, invited, participated, grouped, presented, and associated one or more activities, actions, senses, behavior, events, transactions, requirements, status, auto or manual or physical interactions with other users, video camera, sensors, devices, location, place, and entities, current location and place, map data, preferences, privacy settings, auto recognized or manually inputted list & information of brands used and liked, manually or dynamically or automatically presented categories survey forms to understand user's domain or subject or activities or action or task or workflow specific user preferences, experience, likes, dislikes, selections, comments, reviews, and structured or unstructured information, user generated data, user profile, hit statistics, activity profile, life stream including activities stream and message stream and user associate data.

Another significant objective of the present invention is to provide application network or framework to developers, service providers, advertisers and content or multimedia data providers to develop, register, verify, upload, making them searchable, provide updates, upgrades, support and sell one or more applications, objects, services and content or multimedia data.

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” dynamic & accessible unique identifier including mobile phone number and activity associate or attached dynamic and accessible actions, communication data, updates, requests, responses, or other message, from a device or component includes receiving the communication and message indirectly, such as when forwarded by one or more other devices or components. Similarly, “sending” an item to a device or component includes sending the item indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

Briefly stated, the present invention is directed towards creating social graphs based on unique identifier including mobile phone numbers associated with devices of user and connected users of user and enables to attach, associate and access dynamic, customize, contextual, unified, in-phone number or inline, integrated, trusted, verified, secure, on demand & accessible actions on each unique identifier including mobile phone number, contacts and activity of user and connected users of user, which enables dynamic and customize social networks, groups, workspace, communication, collaboration, e-commerce, viral marketing, advertisements, interactions, sharing, participating activities of other users, creating new connections.

Mechanisms of the invention may enable user to attach, associate and access links of connectable and accessible nodes of network(s) connectable in network(s) environment, wherein said node comprises application, service, object, profile object, connection object, groups, web page, we site, list, interface, widget, messages, attachments, workspace, search results, multimedia data, database, user actions, commands, privacy settings, one or more menus, lists, combo box, interface, windows, toolbar, tab & controls for user selections of one or more options or resources, actions, tasks, binary instructions. A server may receives, stores and processes dynamic & accessible actions associate nodes, associate data, communication and present to the user & connected or related users of user based on privacy settings and preferences.

In one embodiment present invention enables dynamically displaying dynamic and accessible action links with one or more unique identifiers including unique smart phone or mobile phone number(s) and activities.

In one embodiment creating and updating social graphs of network based on list of unique identifier or unique identifiers associate with user devices including unique identifiers associate with user, connected or related users of user, friends, and friends of friends.

In one embodiment Dynamic & Accessible action Server(s) can registering user or mobile phone, assigning unique identity and Uniform Resource Locator (URL) and maintaining and storing profile, preferences, privacy settings, each unique identifier & activity associate dynamic & accessible action links and associate applications, services, objects and connected nodes of the network(s) connectable in network environment, payment information, connections among users, wherein connections based on mobile phone contacts, mobile social graph, social network, incoming phone numbers of mobile and unique identifiers associated with mobiles or smart devices.

In one embodiment unique identifier includes unique phone number, mobile number, email address, IM credentials, URL, links, namespace, URI, IP address, Unique user name, GUID, location, place, activities, actions, keywords, categories and plurality types of unique identifiers:

In one embodiment users are allow to search, match, select, manually or auto attach or associate dynamic and accessible action links with one or more searched, matched, selected unique identifiers and activities.

In one embodiment search, match, select, manually or auto attach or associate dynamic and accessible action links with one or more searched, matched, selected unique identifiers or activities including unique identifiers or activities of user, connected users of user, lists, networks, members, friends, friends of friends based on privacy settings, permissions, preferences, acceptance of invitations of one or more connected users of user or owner(s) of mobile phone number(s).

In one embodiment allowing users, service providers, advertisers to search, match, select, manually or auto attach or associate dynamic and accessible action links with one or more searched, matched, selected unique identifiers or activities including unique identifiers or activities of one or more users and connected users of users, lists, networks, members, friends, friends of friends based on privacy settings, permissions, preferences, acceptance of invitations of one or more connected users of user or owner(s) of mobile phone number(s).

In one embodiment allowing users to apply privacy settings to each connected, related, selected & identified unique identifier to allow to access user's unique identifier or activity specific one or more dynamic and accessible action links.

In one embodiment said privacy settings includes allow each unique identifier of contacts or activity to access each dynamic and accessible action links selected by user or associate with user's unique identifier.

In one embodiment said privacy settings includes apply privacy settings to allow one or more categories group(s) of users, selected connection or unique identifiers, networks, friends of friends up to particular number of depths or degrees of separation, except excluded users, users of particular locations, places, selected or auto matched current or selected locations, places, names, keywords, filters, categories, profile data, user attributes, users related to particular one or more actions, activities, transactions, brands, status, events and search query or structured database queries (SQL) resulted set of users from database to access one or more selected dynamic and accessible action links selected by users or associate with user's phone number.

In one embodiment said privacy settings includes allow to access one or more selected dynamic and accessible action links selected by user(s) or associate with user's unique identifiers including mobile phone number based on rules, conditions, commands, invitations, requests, permission, privacy settings, preferences.

In one embodiment said dynamic & accessible actions links referred to related to one or more objects, applications, user profiles, connections, networks, groups, services, multimedia data, widgets, interfaces, presentations, web pages, web sites, commands, functions, actions, tasks, instructions, lists, databases, attachments, messages, unique identity, workspace, one or more controls including menus, lists, combo box, interface, windows, toolbar, tabs for user selections of one or more options or resources.

In one embodiment said dynamic & accessible actions links and/or associate or attach objects, applications, services multimedia data and connectable nodes of the network(s) develops, creates, host, store, manage, processes, updates, upgrades, publish, present & provided by users, Dynamic & Accessible Actions Server(s), service providers, advertisers and 3rd parties developers.

In one embodiment said links related to or enables dynamic and accessible user actions, activities, events, tasks, workflow, communication, collaboration, sharing, transactions, functions, selections, interactions, and participating activities of owner of unique identifier.

In one embodiment displaying dynamic and accessible action links to set of user or determined user based on searching, matching, selecting unique identifiers including phone numbers of connected users of user, membership, contacts, connections, subscriptions, incoming phone numbers of anonymous or connected users, selections of one or more phone numbers or URLs or unique identity & name, sending request or inviting others for approval, search people, find friends from contacts, categories lists, auto match making, wherein auto match making based on user actions, activities, interactions, transactions, events, locations, status, behavior, profile & user data of user and connected or matched users of user, rules, conditions, ranks, preferences including keywords, categories, source, privacy settings and any combination thereof.

In one embodiment create categories lists of unique identifiers and associate dynamic & accessible actions links based on privacy settings and preferences.

In one embodiment enable users to share said one or more categories lists of unique identifiers and/or associate dynamic & accessible actions links with set of users or determined users.

In one embodiment the sender or source and receiver each comprise a user, connected users of user, providers, developers, service providers, central server unit, user computer system, digital source, user application, telephone or mobile, smart devices, automated message(s) source, external domains including web sites, applications, services, devices, networks, databases, social networks, sensors, multi Artificial Intelligence Agent(s), translation system, or speech or voice message(s) source(s) and allowing the user to access said system or part of system from one or more communication channels, applications, services, smart devices, networks, social networks, external domains, communication networks, non-social networks, centralized or peer to peer networks, web sites.

In one embodiment present unique identifier including mobile phone number and activity specific dynamic & accessible action links when user selects unique identifier including mobile phone number, hover on particular contact or unique identifier, before, during and after calling of particular mobile phone number and selecting & auto identifying activities.

In one embodiment managing nodes and connections among nodes in a network comprising steps of:
maintaining in a database a plurality of nodes of a social graph, wherein nodes including phone numbers of users, connected users of users, user activities, dynamic and accessible actions associate objects;
maintaining in a database a plurality of connections in the social graph, where each connection represents a connection between two or more nodes in the social graph;
maintaining in a database information about one or more of the nodes, actions, transactions, communications, connections & interactions among nodes;
enable to search, match, select, manually or auto attach or associate or identify dynamic and accessible action links with unique identifier including mobile phone number; and
presenting dynamic and accessible action links with unique identifier including mobile phone number to set of viewing user.

In one embodiment enable to auto generating or creating, auto determining, auto searching & matching, auto selecting, auto detecting, auto sensing, auto posting or presenting, auto updating dynamic & accessible actions or dynamic & accessible action links.

In one embodiment enable to create and update one or more categories lists of dynamic & accessible actions or dynamic & accessible action links or dynamic & accessible connectable nodes of network(s).

In one embodiment said categories list created based on user selection, search & match, suggested & provided by connected & matched users of user, suggested list, auto generated list based on user profiles, user data, user activities, user actions, past responses, interest, list of connected users, installed applications, uploaded by user and presented by 3rd parties developers, service providers and advertisers based on users privacy settings and preferences.

In one embodiment said associate data of dynamic & accessible actions comprising reference URL or namespace of each dynamic & accessible actions for identifying and allowing to access dynamic & accessible actions link associate objects, applications, services, media data, people, entities, identities, profile, group, network, page and other objects of network, dynamic & accessible actions related one or more metadata, categories, keywords, sources, providers, details, descriptions, properties, links, attachments, features, upload, created & use date & time, help, identifier & profile(s) of sender & receiver of dynamic & accessible actions, dynamic & accessible actions associate tracking status & status, dynamic & accessible actions associate object related user data and preferences, security policies, authentication information and privacy settings of accessing & sharing dynamic & accessible actions and dynamic & accessible actions associate object(s) related user data.

In one embodiment verify and register dynamic & accessible action links and associate reference items or objects.

In one embodiment said dynamic & accessible action links and associated or attached reference items or objects provided and host by the central unit, users, connected users of user, 3^{rd} parties' developers, service providers and advertisers.

In one embodiment storing interactions of between or among user, connected users of user and dynamic & accessible action links and associated or attached reference items or objects.

In one embodiment user can share selective user profiles and user data with connected or related users, central unit, external domains, and service providers based on privacy settings and preferences.

In one embodiment said dynamic & accessible action links and associated or attached reference items or objects manage and invoked in an integrated environment.

In one embodiment enabling user to take one or more user actions on one or more unique identifiers and/or dynamic & accessible action links and associated or attached reference items or objects wherein said user actions comprising apply privacy settings & presentation settings, search, match, share, filter, sort, order, group, categories, bookmark, attach, detach, add, update, delete, update, upgrades, categories, group, view logs, invitations, sent requests, actions, transactions, events, activities & communications details, report spam, abuse & violation, set tracking status, provide comments & ranks.

In one embodiment managing dynamic activities associate dynamic actions related to unique identifier comprising: enabling to manually define, search, match, select, update and present one or more activities or auto match, determine, detect, sense, recognize, identify and present one or more user activities; manually or dynamically or automatically search, match, determine, select, attach said each activity associate dynamic & accessible actions; and dynamically present one or more said dynamic & accessible actions with said each activity.

In one embodiment monitoring, determining, storing, searching, matching, selecting, creating, auto recognizing, detecting, identifying, presenting user activities; dynamically present activity specific dynamic & accessible action links; and allow to access said dynamic & accessible action links.

In one embodiment presenting user query, search, match making preferences, keywords, categories, selections, actions, senses, location, status, events, transactions, behavior, user profile, user data, categories survey forms, rules, conditions, commands specific dynamic and accessible action links to user, connected or related users of users, subscribers, 3^{rd} parties service providers, developers, advertisers, experts, external domains, web sites, applications, services, networks, devices, sensors, automated sources to facilitate each others in participation, dynamically creating groups, social networks, solving particular workflow & tasks, sell or buy or market products and services, provide coupons, provide services, provide medicines, provide foods, communicate, collaborate, share multimedia data including text, URLs, videos, images, photos, objects, applications, files, present advertisements, sensor detected and provided actions, provide directions, suggestions, instructions, health tips, answer of question, search query specific search results and plurality types of human mediated or automated services.

In one embodiment metadata & data associate with activities comprising activity profile, activity type, activity name or label, activity identity & URL, public or private activity type, activity structured or unstructured details, author of activity, actor identity & profile, one or more participants identity & profiles, date & timings, locations, activity associate one or more dynamic & accessible action links and associate referenced one or more applications, services, objects, connectable or connected nodes of network connected in network environment, multimedia data, user actions, dynamic application features, interface, controls, instructions, commands, rules, networks, groups, lists, attachments, messages, connection & profile objects and databases, details of acting on activities including user's and connected users' or participants' interactions, actions, transactions, behavior associate with activity, status of activity, privacy settings, preferences, rules, conditions, categories, keywords associate with activity, similar or alternative activities, similar types of activities related matched data, payment & transaction information, related part of social graph.

In one embodiment user or on behalf of user connected users of user, providers, service providers, developers, external domains, central server unit can manually or automatically define, search, match, select, associate, attach, share, participate, manage, maintain, update, present one or more activities.

In one embodiment user or on behalf of user connected users of user, providers, service providers, developers, external domains, central server unit can manually or automatically manage, maintain, define, create, search, match, select, filter, attach, detach, update, edit, associate, present, categories, sort, order, rank, associate metadata, profile, and maintain data including monitoring, tracking and storing data related to each entities interactions with said activities, detect, sense, identify, recognize, store, process one or more activities or actions including defined, auto identified or detected or sensed or inferred or recognized, user created, edited, updated, current, prospective, suggested, liked, determined, connected, related, contextual, undefined, excluded, blocked, removed, detached, past, present, future, presented, selected, inferred, transformed, possible in near future activities.

In one embodiment monitoring, tracking, storing and maintaining interactions, user actions, transactions, behavior, status of user, connected users of user, dynamic & accessible links with activities.

In one embodiment automatically and dynamically search, auto or manually match and determine activity associate dynamic actions based on user's privacy settings, preference, user inputs including details, commands, rules, instructions, selections, user data, user profile, user interacted or participants data and activity type metadata, select, filter, attach, detach, associate, purchase, order customized, select template and select or edit or update or customize from template or tags, select from suggested or auto match list provided by connected users of user including friends, friends of friends, part of social graph, providers, service providers, external domains, and central server unit, one or more dynamic & accessible action links.

In one embodiment dynamic & accessible link further comprises one or more associated dynamic & accessible links.

In one embodiment unique identifiers associate list of Dynamic & Accessible Actions Links can dynamically adds, updates, removes, changes based on user current location(s) or places, sensors, user actions, activities, behavior, instructions, commands, interactions, transactions, status, senses including voice, touch, vision, detection of user image in video or photo, movement, taste, smell, status, triggering of events, closeness of other mobile phones or smart devices of members of Dynamic Actions Network(s).

In one embodiment enable users to subscribe one or more dynamic & accessible action links based on selections of one or more sources, categories, keywords, privacy settings, rules, conditions, auto match making criteria based on preferences, user profile, user data, user actions, activities, transactions, behavior, status, triggering of events, interactions with providers profile, dynamic & accessible action links associate metadata, categories, keywords.

In one embodiment one or more unique identifiers related to same entity or different entity and same device & clients or different devices or clients may have associated same set of dynamic & accessible links.

In one embodiment presenting set of dynamic & accessible links based on one or more formats and styles including list, visual, menu, tree, inline, tabular, buttons, images, page, highlighted, hover & present, and customize presentations.

In one embodiment enable user to hover on dynamic & accessible action links and can select, order, categories, organize, share, remove, attach, detach, provide ranks & comments, view help, profile & metadata, apply privacy settings & preferences, request for support, purchase, upgrade & updates dynamic & accessible action links.

In one embodiment Dynamic & Accessible Actions Server can dynamically provide, update, synchronize and publish one or more or list or categories contextual, related useful, advertised, suggested and matched unique identifiers including mobile phone numbers, landline phone numbers, user identities or names, email addresses, web site URLs, categories activities with associated or attached dynamic & accessible action links based on auto math making, reference given by connected or related users of user, user preferences, survey data, user data & profile(s), user actions, activities, transactions, connections, subscriptions, selections, behavior, current location or place, triggering of events, status, interactions, and matching advertisement(s) targeting criteria with user data.

In one embodiment enable user to search, match, select, filter, attach, allow and receives one or more unique identifiers and associate dynamic & accessible action links presented, suggested & provided by Dynamic & Accessible Actions Server, providers, external sources, advertisers, users of Dynamic & Accessible Actions Network(s), connected or related or matched users of user.

In one embodiment enable user to share, forward, synchronize, refer, submit, publish, provide and present one or more one or more unique identifiers and/or associate dynamic & accessible action links with the permission of related provider and/or owner or source of unique identifiers and dynamic & accessible action links.

In one embodiment enable user to post one or more dynamic & accessible action links based on selection from categories list(s) of dynamic & accessible action links, entering name or reference URL of dynamic & accessible action links, select from auto matched list(s) of dynamic & accessible action links, select unique identifiers and select from list of associate dynamic & accessible action links to one or more users of networks and selected or connected or related users of user, subscribers, preference based matched users, travel user's social graph up to particular number of depth or degrees of separations.

In one embodiment enable user to attach or associate one or more dynamic & accessible action links via searching, matching, filtering, selecting and attaching or associating one or more dynamic & accessible action links from categories list(s) of dynamic & accessible action links, wherein said one or more selectable categories list(s) dynamic & accessible action links of are presented based on user's search queries, match making preferences, one or more filters including source or providers name, locations, categories, paid or free types, rank and other filter criteria, selecting specific types of dynamic & accessible action links including default or system or Dynamic & Accessible Action Server provided dynamic & accessible action links, provider specific, categories activities specific, purchased or subscribed, dynamic & accessible action links related or connected or related users of user, dynamic & accessible action links suggested by Dynamic & Accessible Action Server, connected users of user, advertisers, providers, 3rd parties or external domains and matched users of network or auto matched dynamic & accessible action links based on user data, profile, privacy settings, preferences, activities, actions, interactions, status, behavior, locations, and transactions, categories list or directories of dynamic & accessible action links, bookmarked dynamic & accessible action links, invited, shared, user created and search result specific dynamic & accessible action links, dynamic & accessible action links related to particular types applications, services, multimedia data types, objects, networks, groups, database, lists.

In one embodiment enable user to search, attach, detach, and associated with one or more defined, created, selected, matched, current, auto identified or detected or sensed or recognize, shared, suggested, participated, associated activities and select one or more dynamic & accessible action links

In one embodiment enable user to apply privacy settings for each attached or associated and selected dynamic & accessible action link(s) for enabling one or more selected users to allow to access said dynamic & accessible action link(s) and enables them to view & access user's shared contents, communicate, collaborate, share, publish, and participate with user's activities, wherein privacy settings can apply via list of privacy settings selections including allow everyone, allow all networks and friends of friends or members, allow only to friends of friends, allow only to user's connected users or friends, allow only to members of networks, allow only selected networks and/or friends and/or friends of friends and/or members of network(s) and/or selected unique identifiers including unique mobile phone numbers, email addresses, website URLs, one or more types or categories or keyword specific activities related or matched or connected one or more users, one or more selected or all subscribers or bookmarked, selected one or more or part of groups or categories lists or allow only to results of search queries, keywords, categories, conditions, filters, auto matchmaking preferences specific users, friends, friends of friends, members and networks to access said selected dynamic & accessible action links.

In one embodiment enable user to individually search, match, filter, select users from list, which are presented based on user selection of types of privacy settings and selection of one or more networks, groups, lists, categories, auto group.

In one embodiment enable user to select one or more friends, users of networks, friends of friends, members, lists, unique identifiers for excluding to allow to access one or more said selected dynamic & accessible action links.

In one embodiment enable user to invite one or more users including connected or related users of user and selected unique identifiers for acceptance of allowable dynamic & accessible action links by receiving user.

In one embodiment enable user to accept requests of one or more other users to allow receiving their dynamic & accessible action links at user's interface.

In one embodiment enable user to take one or more user actions on one or more selected or group(s) of unique identifiers including mobile number(s), email addresses, website URLs including search, match, filter, sort, remove, block, attach, detach, categories, share, synchronize associate dynamic & accessible action links and/or associate user data and/or associate profile, update, publish, rank, provide comments & descriptions, bookmark, add or update photos or profile, view information, apply privacy settings for allow limited access to one or more connected users or receivers or subscribers and plurality of dynamic and customized user or system defined or created user actions.

In one embodiment enable user to filter user's social graph and access filtered social graph and to search, match, share, attach, detach, remove, block, access, update and apply privacy settings to user's social graph.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

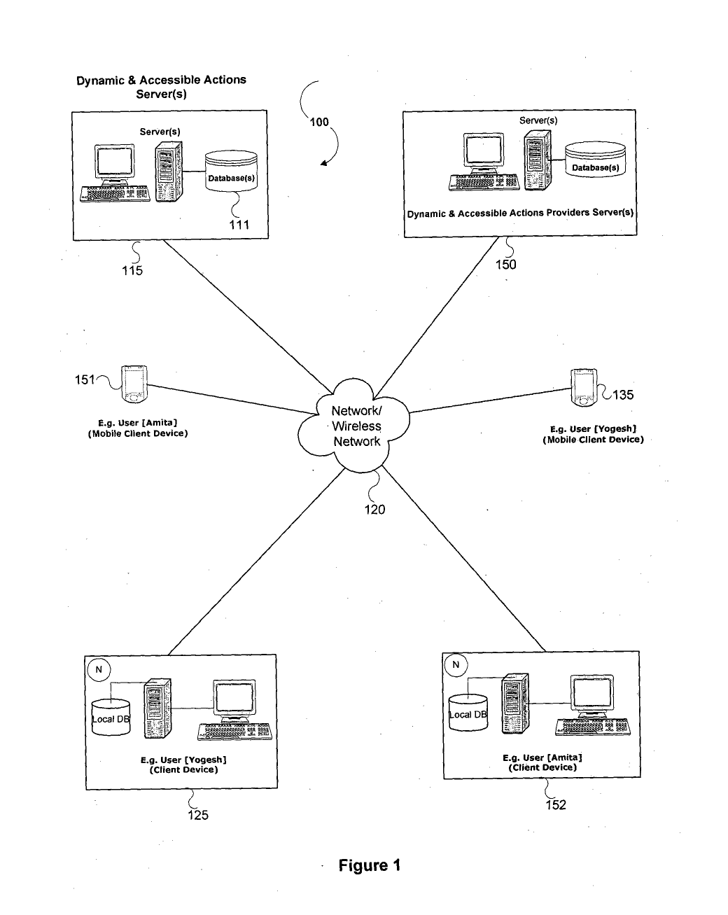

FIG. 1 is a system diagram of one embodiment of an environment in which the invention may be practiced;

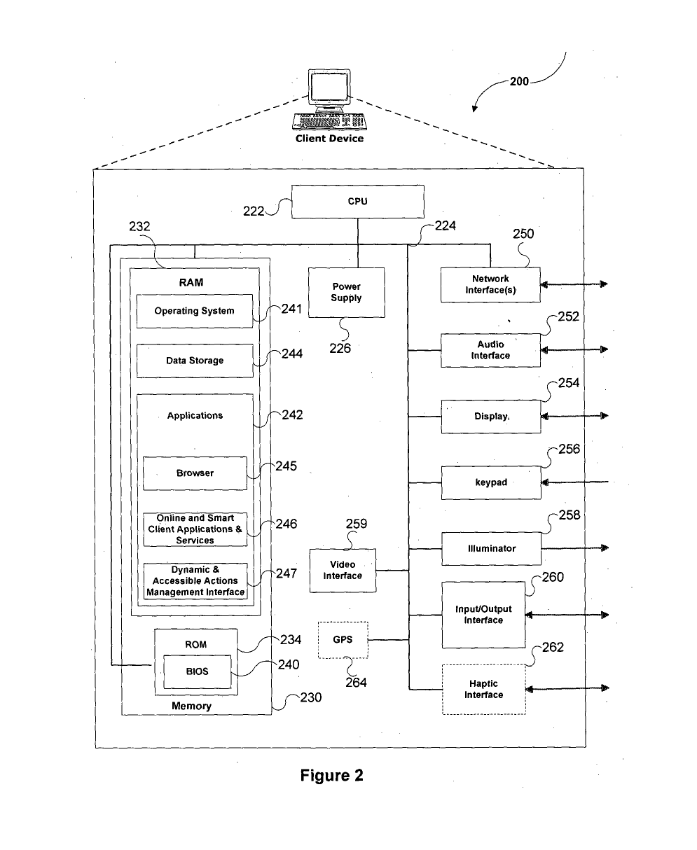

FIG. 2 shows one embodiment of a client device that may be employed in a system implementing the invention;

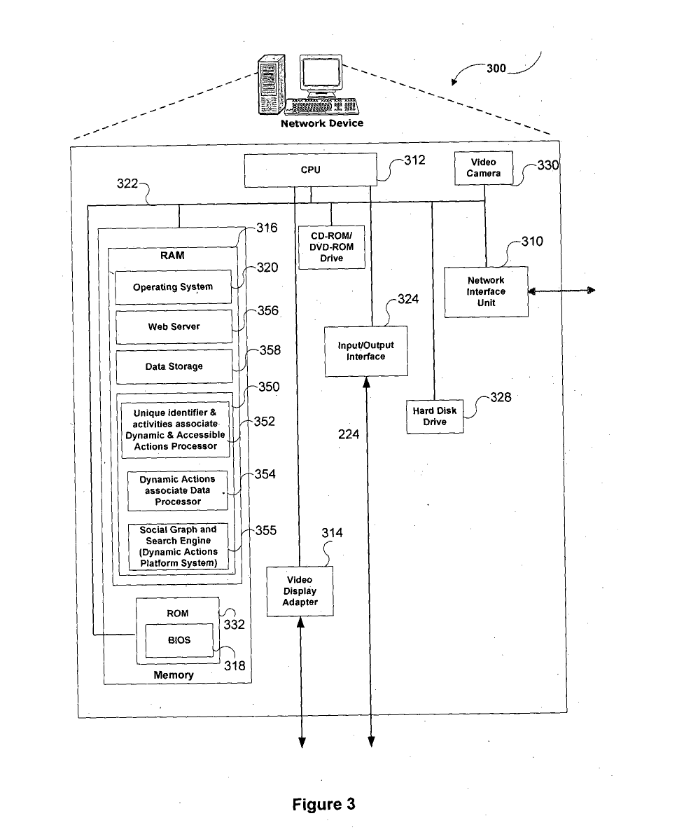

FIG. 3 shows one embodiment of a network device that may be employed in a system implementing the invention;

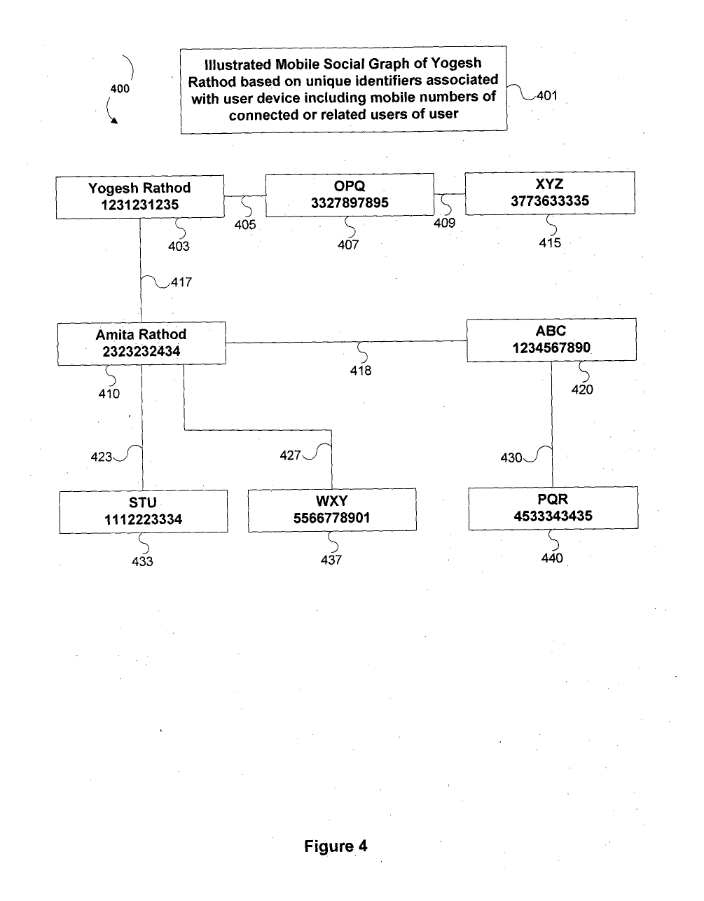

FIG. 4 illustrates social graph's created based on unique identifiers related to user and connected users of user including mobile phone numbers, email addresses, website URLs, user activities;

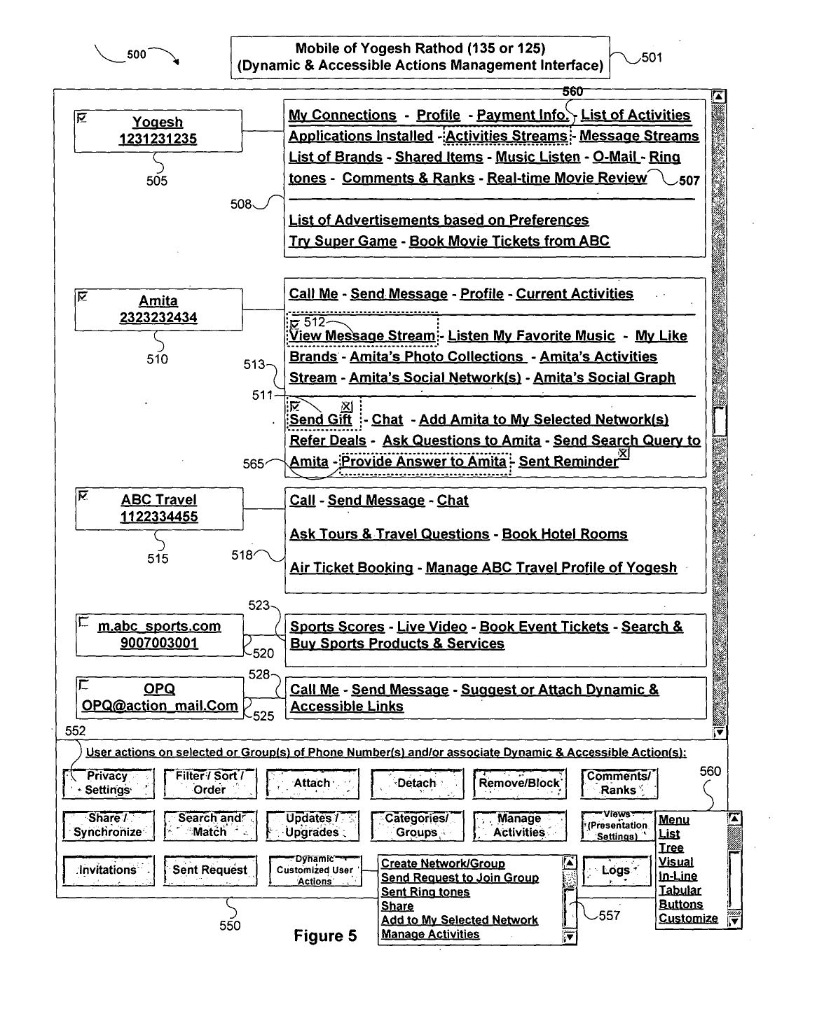

FIG. 5 illustrates exemplary graphical user interface (GUI) or Dynamic & Accessible Actions Management Interface of User [Yogesh] 135 which shows User [Yogesh] 135 related or connected or contact phone numbers and unique identifiers associate set of dynamic & accessible action links which are attached or associate by user, connected or related users of user and provided or created by user, connected users of user, providers, service providers, external domains, developers, Dynamic & Accessible Action Server or Network;

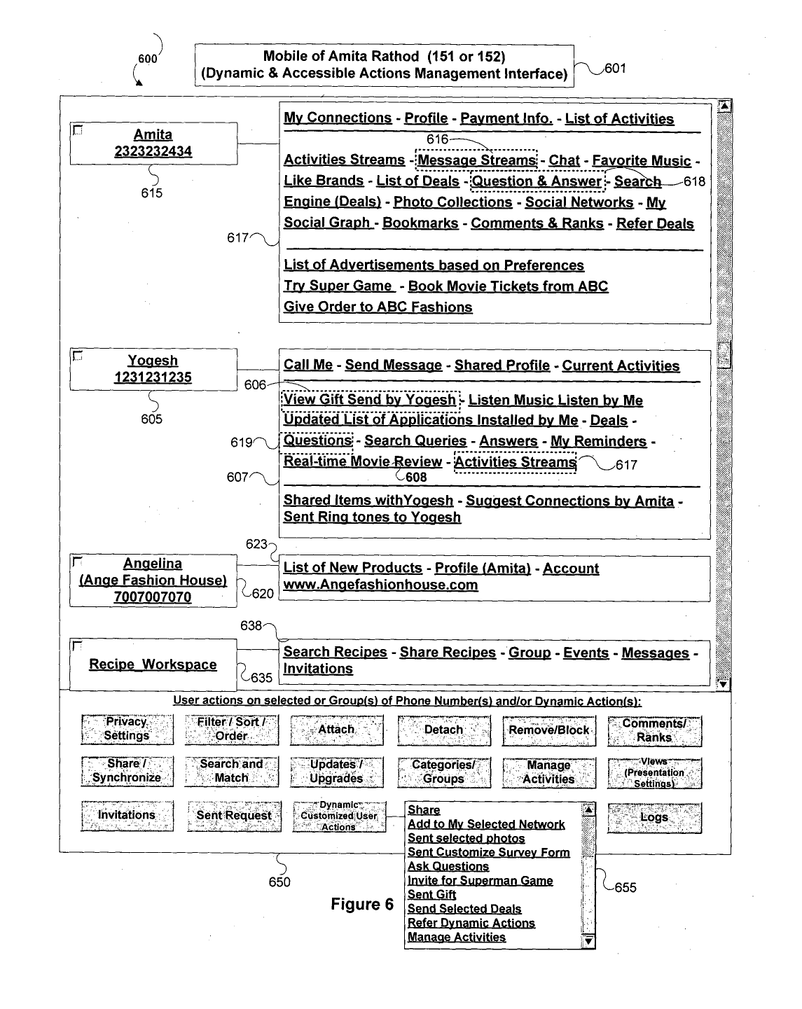

FIG. 6 illustrates exemplary graphical user interface (GUI) or Dynamic & Accessible Actions Management Interface of User [Amita] which shows User [Amita] related or connected or contact phone numbers associate set of dynamic & accessible action links which are attached or associate by user, connected or related users of user and provided or created by user, connected users of user, providers, service providers, external domains, developers, Dynamic & Accessible Action Server or Network;

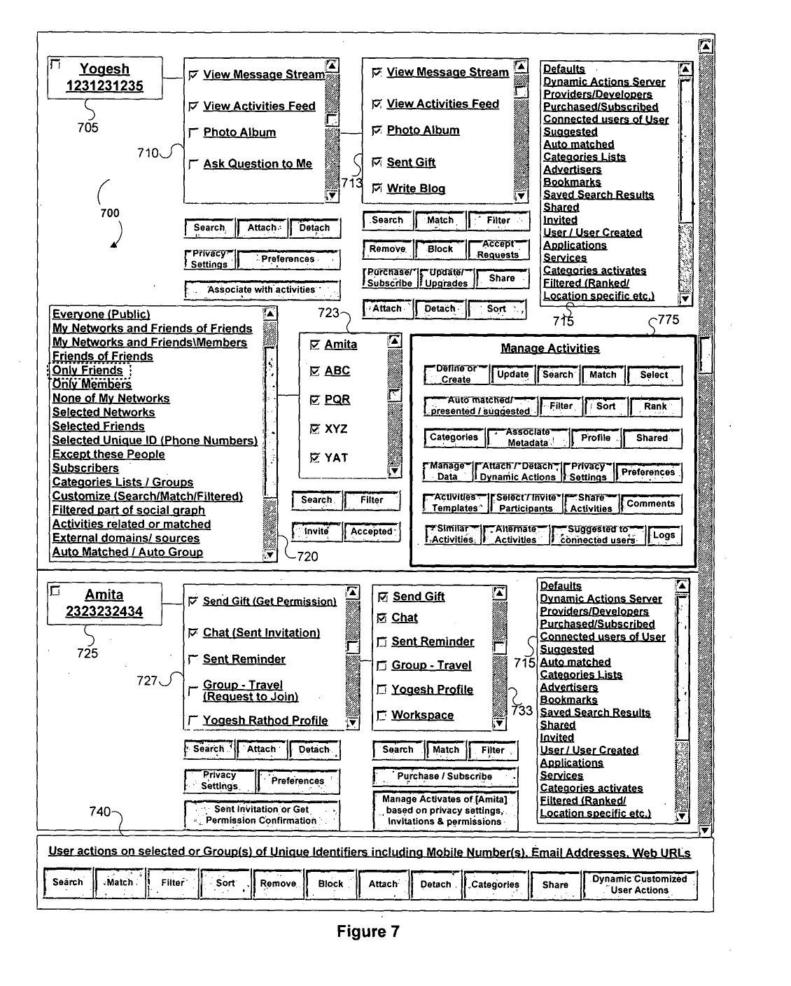

FIG. 7 illustrates exemplary graphical user interface (GUI) for searching, matching, selecting, attaching, associating dynamic & accessible links with unique identifier of user and/or connected users of user and providing privacy settings to each dynamic & accessible links of user for allowing one or more connected users of user to access one or more dynamic & accessible links associate with unique identifier of user;

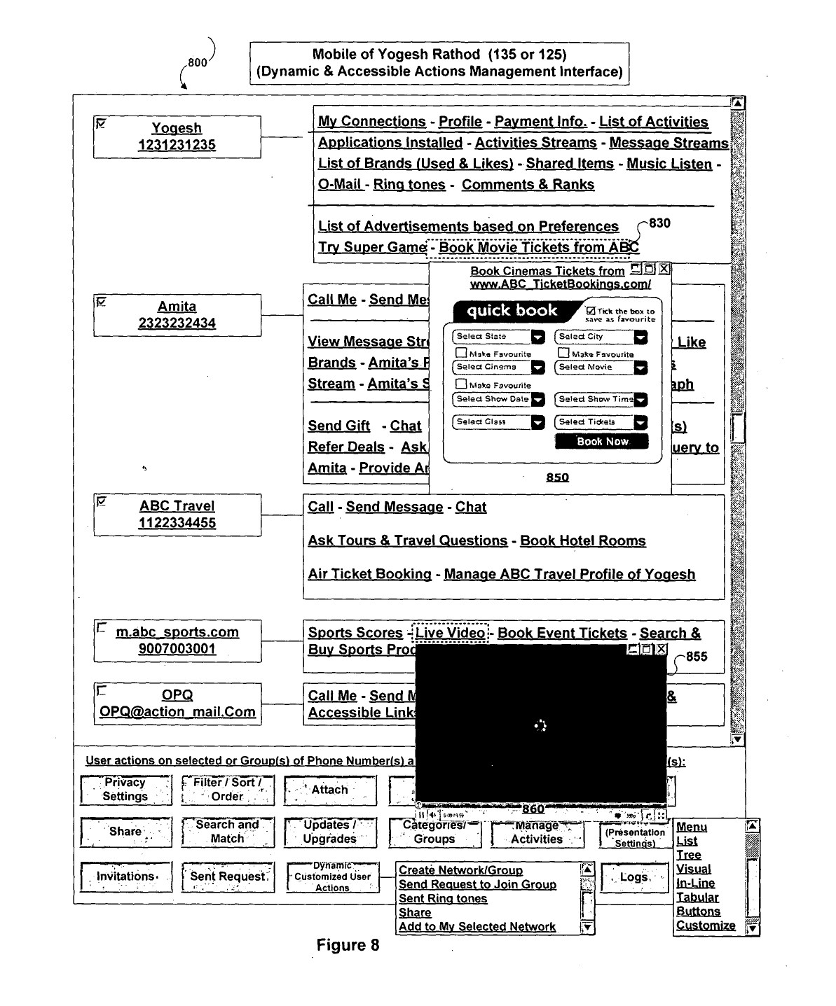

FIG. 8 illustrates exemplary graphical user interface (GUI) for demonstrating various examples;

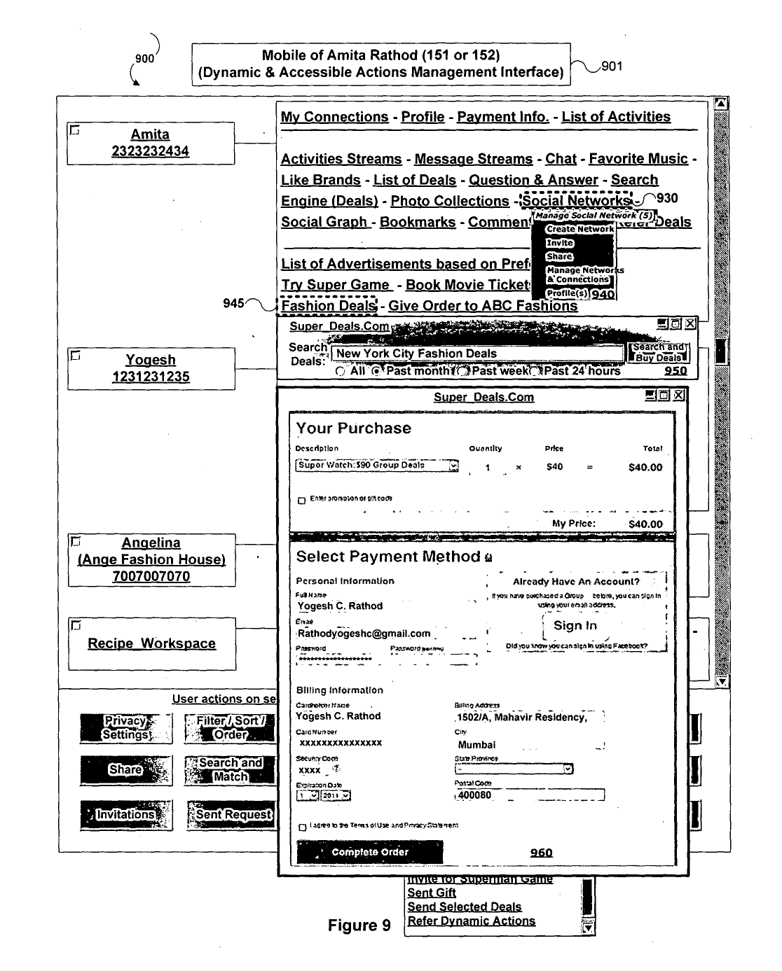

FIG. 9 illustrates exemplary graphical user interface (GUI) for demonstrating various examples;

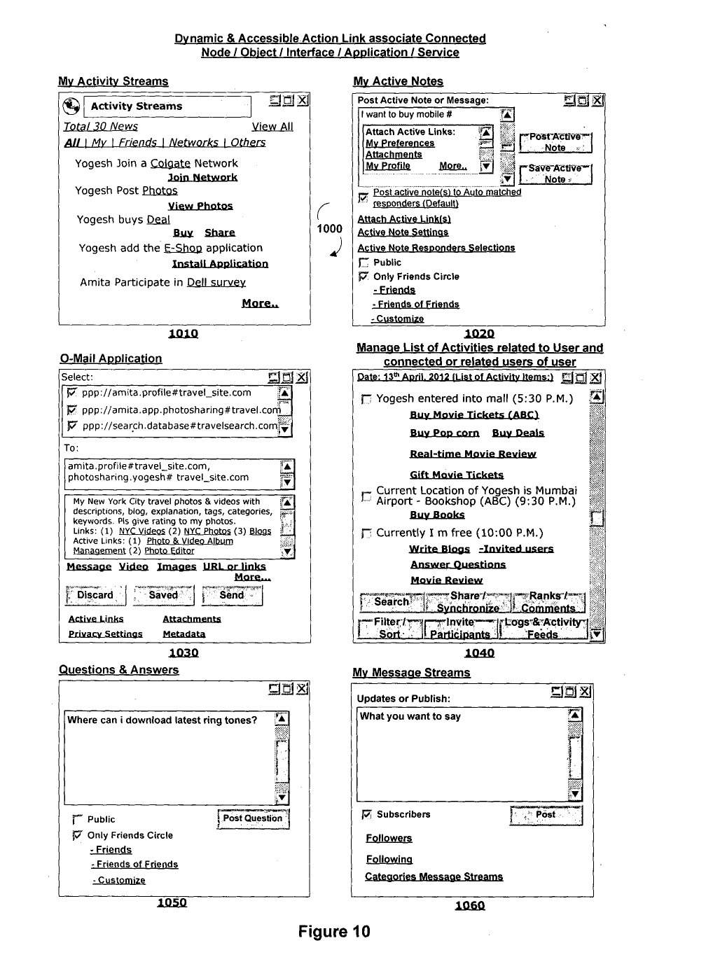

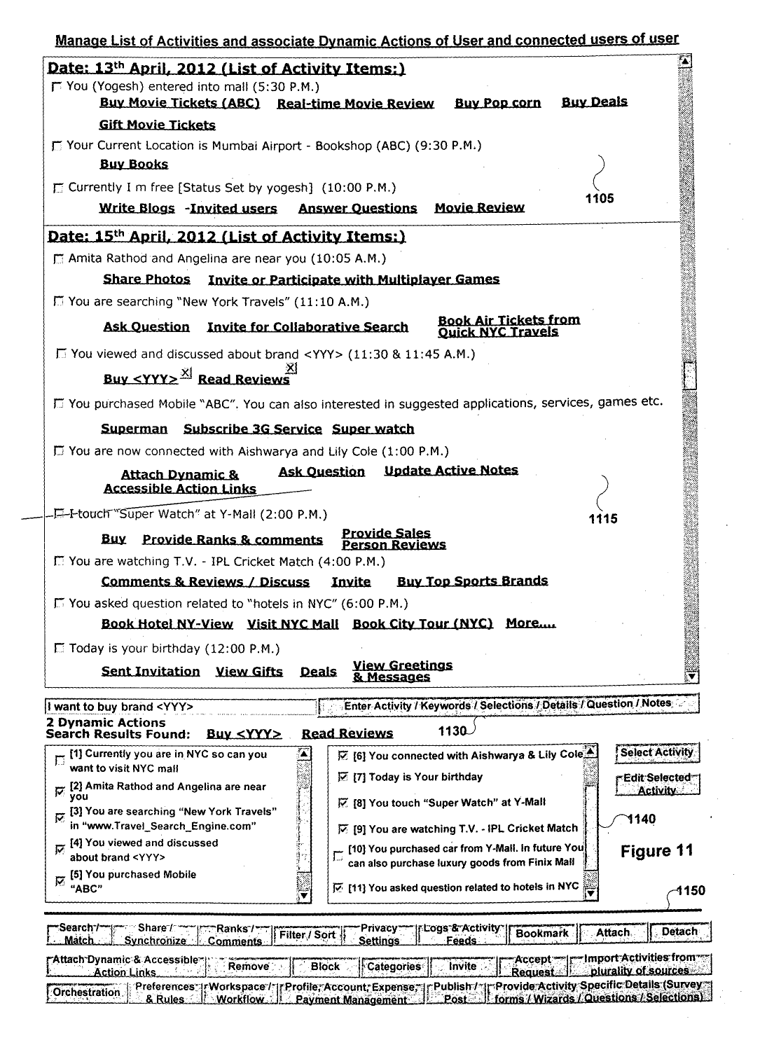

FIGS. 10, 11 & 12 illustrates exemplary graphical user interface (GUI) for demonstrating various examples;

### DETAILED DESCRIPTION OF THE DRAWINGS

Illustrative Operating Environment

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes a client device, in particular mobile device 135 and personal computer 125. The system also includes network or wireless network 120, central server 115, Dynamic & Accessible Actions Providers Server(s) including Contents, Applications & Services, and Advertisers Providers 150, and client devices 151 & 152 and 125 & 135.

A variety of client devices may be employed in accordance with the invention. The client devices may include mobile devices, digital home clients such as personal computers and media centers, and other client devices. Generally, mobile device 135 may include virtually any portable computing device capable of receiving and sending a message over a network, such as network 130, or the like. Mobile device 135 may also be described generally as a client device that is configured to be portable. Mobile device 135 may have the capability of connecting to a network using wireless technology, wired technology, or a combination of both wired and wireless technologies. Thus, mobile device 135 may include virtually any portable computing device capable of connecting to another computing device and receiving information. Such devices include portable devices such as cellular telephones, smart phones, display pagers, radio frequency (RF) devices, infrared (IR) devices, Personal Digital Assistants (PDAs), handheld computers, sensors, laptop computers, wearable computers, tablet computers, integrated devices combining one or more of the preceding devices, and the like. As such, mobile device 135 typically ranges widely in terms of capabilities and features. For example, a cell phone may have a numeric keypad and a few lines of monochrome LCD display on which only text may be displayed. In another example, another cell phone or web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, video, multimedia, and the like, employing virtually any web based language or protocol, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile device 135 may include one or more other client applications that are configured to receive content from another computing device. The client application may include a capability to provide and receive textual content, graphical content, audio content, video content, and the like. The client application may further provide information that identifies itself, including a type, capability, name, and the like. In one embodiment, mobile device 135 may uniquely identify itself through any of a variety of mechanisms, including a phone number, Mobile Identification Number (MIN), an electronic serial number (ESN), or other mobile device identifier. The information may also indicate a content format that the mobile device is enabled to employ. Such information may be provided in a message, or the like, sent to central server 115 or other computing devices.

Mobile device 135 may also be configured to communicate a message, such as through Short Message Service (SMS), Multimedia Message Service (MMS), instant messaging (IM), internet relay chat (IRC), Mardam-Bey's IRC (mIRC), Jabber, and the like, between another computing device, such as central server 115, another web server, or the like. However, the present invention is not limited to these message protocols, and virtually any other message protocol may be employed.

Mobile device 135 may be further configured to enable a user to participate in communications sessions, such as IM sessions. As such, mobile device 135 may include a client application that is configured to manage various actions on behalf of the client device. For example, the client application may enable a user to interact with the browser application, email application, IM applications, SMS application, and the like. Generally, instant messaging provides ability for at least two computing devices to exchange messages in real time.

Mobile device 135 may further be configured to include a client application that enables the end-user to log into an end-user account that may be managed by a network application. Such an end-user account, for example, may be configured to enable the end-user to receive emails, send/receive IM messages, SMS messages, and access selected web pages, maintain a digital wallet, or the like.

Network 120 is configured to couple mobile device 135, 151 & Personal Computer 125 & 152, as well as other client devices not illustrated, and their components, with other network devices, such as central server 115, and the like. Network 120 is configured to couple responder client devices including mobile phone 135, 151 & Personal Computer 125 & 152 with central server 115.

Though for illustrative purposes network and wireless network are shown combined, in various environments employing the present invention, network and wireless network 120 may be the separate or same network, different networks, or different networks including a combination of overlapping components and distinct components. The discussion herein that describes network 130 may therefore be applicable to describe network 120.

Network 120 may include any of a variety of wired or wireless sub-networks that may further overlay stand-alone ad-hoc networks, and the like, to provide an infrastructure-oriented connection for mobile device 135. Such sub-networks may include mesh networks, Wireless LAN (WLAN) networks, cellular networks, and the like. Additionally, network 120 may connect to mobile devices with a wired connection, such as cable, phone lines, Ethernet wires, and the like. Network 120 may include wide area networks, such as the Internet. The invention may be used either generally with networks, specifically with wireless networks, or with various combinations of wireless and wired networks.

Network 120 may further include an autonomous system of terminals, gateways, routers, and the like connected by wireless radio links, and the like. These connectors may be configured to move freely and randomly and organize themselves arbitrarily, such that the topology of network 120 may change rapidly.

Network 120 may further employ a plurality of access technologies including 2nd (2G), 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as mobile device 135 with various degrees of mobility. For example, network 120 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, network 120 may include virtually any communication mechanism by which information may travel between mobile device 135 and another computing device, network, and the like.

Network 120 may further include or employ one or more network gateways (not shown) that serve as intermediaries between mobile device 135 and other network devices, such as central server 115. A network gateway may receive data from a device or network, transform the data, and forward the data to another device or network. A network gateway may perform a transformation in more than one direction. Transformation may, for example, include modifying protocols or communications mechanisms in order to facilitate communication between two devices or two networks, each of which may employ differing protocols. A WAP gateway is one type of network gateway. A WAP gateway may facilitate communication between a first device that uses the Wireless Application Protocol (WAP), and a second device. The second device may, for example, communicate using the HyperText Transfer Protocol (HTTP). An SMS gateway is a network gateway that facilitates communication between a device using the Short Message Service (SMS) protocol and another device, such as one using HTTP. A WAP and SMS gateway combines the features of a WAP gateway and an SMS gateway.

In one embodiment, network 120 may include one or more components of a Dynamic & Accessible Actions Management Interface and service that operates to facilitate or enable attach, associate, share, present and access dynamic actions on unique identifier including mobile phone number and communication between mobile devices 135, 151 and smart device 125 & 152 and central server 115.

FIG. 1 shows mobile device 135 communicating with central server 115, and central server 115 communicating with Dynamic & Accessible Actions Providers Server(s) including Contents, Applications & Services, and Advertisers Providers 150. FIG. 1 also shows central server 115 communicating with client devices 135, 151, 125 & 152. Each of these communications may employ a direct connection, or one or more networks, or a combination thereof. For illustrative purposes, FIG. 1 does not show communication between central server 115 and Dynamic & Accessible Actions Providers Server(s) including Contents, Applications & Services, and Advertisers Providers 150 employing network 120, however environments that include this communication may be employed with the present invention. In particular, central server 115 and Dynamic & Accessible Actions Providers Server(s) including Contents, Applications & Services, and Advertisers Providers 150 may employ any one or more of direct communication, a local area network, or a wide area network, such as network 120.

A network enabling any one or more of the above communications may employ any form of computer readable media for communicating information from one electronic device to another. Also, the network may include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, the network includes any communication method by which information may travel between central server 115, Dynamic & Accessible Actions Providers Server(s) including Contents, Applications & Services, and Advertisers Providers 150, client devices 151,152, 125 & 135, and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Client devices 151, 135, 125 & 152 are computing devices that may be employed by a user, referred to as a receiver and sender, for receiving and sending dynamic & accessible action links. A variety of sender and/or receiver client devices may be employed in accordance with the invention. Client devices may include mobile devices, digital home clients such as personal computers and media centers, and other client devices. Generally, clients may include virtually any computing device, portable or non-portable, capable of receiving and sending a message over a network, such as network 120, or the like. Clients may include devices such as mobile device 151 (135) described herein. Though FIG. 1 illustrates only four Clients 151, 135, 125 & 152, it is envisioned that the invention may be practiced in an environment that include a large community of sender and receiver clients. Thus, sender and receiver clients or members of network or Dynamic & Accessible Actions provider or user or receiver may number in the hundreds, thousands, hundreds of thousands, millions, or virtually any number.

Though FIG. 1 illustrates an embodiment of a system having each of network central server(s) 115 and Dynamic & Accessible Actions Providers Server(s) including Contents, Applications & Services, and Advertisers Providers 150 as separate computing devices, the invention is not so limited. Software, hardware, or hardware-software combinations implementing any portion of these components may be combined with any other component on a single computing device, or arranged in a different manner among multiple computing devices. Some portion or all of the functionality of any component may be distributed or duplicated among multiple computing devices.

One embodiment of a network device that may be used to implement any one or more of central server 115 or Dynamic & Accessible Actions Providers Server(s) including Contents,

Applications & Services, and Advertisers Providers 150 is described in more detail below in conjunction with FIG. 3. Briefly, however, such network devices may include any computing device capable of communicating with other network devices to enable network applications or web sites to process, send and respond to requests from client devices, such as mobile device 135 is described in more detail below in conjunction with FIG. 2. Devices that may operate as these network devices include personal computers desktop computers, multiprocessor systems, microprocessor-based or programmable consumer electronics, network PCs, servers, and the like, or any combination thereof.

FIG. 1 illustrates an embodiment of a system having an ads server 150. Briefly, an advertisings server provides advertisements, such as banner advertisings, application advertisings or other types of advertisements. An application advertisement is an advertisement that is associated with an interaction with an application. It is typically integrated with the application presentation in some way. A search advertising is an example of application advertisings. When a search is performed, a search application may select one or more ads based on the keywords of the search. The search application may combine search ads with the search results, and present them in an integrated manner. In some embodiments, the integration may be so complete that there is not a clear distinction between the search ads and the search results. In some embodiments, one or more ways of indicating the search ads may be included, such as text, color, line separators, and the like. Similarly, other applications may generate application ads. A mapping application, for example, may use the location specification in a request to generate advertisements based on the location, such as those of businesses in the area, and may display an advertisement on the map.

A banner advertisement typically is placed in a location that is separate from, or more distinguishable from, an application's results. For example, it may be at the top or bottom of a page, or along the margin. A banner advertisement may be selected based on criteria similar to those for an application ad, based on different criteria, or randomly selected

Ads server 150 may have an associated ads database, which may be integrated or in communication with ads server 150. An ads database may store data pertaining to advertisement contents, constraints, and rules pertaining to the use of each advertisement. At least a portion of the data stored in ads server 150 may be specified by an advertiser. An advertiser may specify data describing the advertisement contents, constraints, and rules pertaining to the use of each advertisement.

Ads server 150 may receive data or a set of parameters to use for determining whether to provide an advertisement, selecting and generating an advertisement, including data upon which various determinations are made. Selecting and generating an advertisement may include selecting an advertiser, selecting an advertisement associated with the advertiser, or selecting content to include in an advertisement. The data upon which these and other determinations may be based may include information derived from user data, user profile, information related to interactions among users and dynamic & accessible actions links and associate references nodes or objects received by the central server, and the like. The data upon which these and other determinations may be based may also include information about the user or mobile device, actions that the user or mobile device have taken, data pertaining to one or more advertisers, relevant events, and a variety of other types of information.

FIG. 1 illustrates an embodiment in which mobile device 135 communicates with central server 115. A user of mobile device 135, referred to as a provider and/or receiver of dynamic & accessible action links, based on privacy settings of provider and/or receiver, may employ mobile device 135 to send and/or receive dynamic & accessible action links to central server 115. Central server 115 may receive and process the dynamic & accessible action links associate with unique identifier(s) including mobile phone number(s) from mobile device 135. Central server 115 may select a set of connected or related users of user devices 151 and 152. Central server 115 may employ identifiers or addresses of senders and receivers devices, or both. It may, for example, employ a login name or email address of a sender and/or receiver. It may employ an IP address, MIN, or other identifier of a device. Central server 115 may employ any one or more of these identifiers or addressing mechanisms when communicating with a sender and/or receiver device. As used herein, unless the context clearly indicates otherwise, the term “sender” and “receiver” may be used to refer to a person, a device, or a combination of a person and a device.

Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, user client devices 151, 152, 125 and 135 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, an optional haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Optional haptic interface 262 is arranged to provide tactile feedback to a user of the client device. For example, the optional haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SM, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may, through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as Windows Mobile™, or the Symbian® Operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 including browser 245, online and smart client applications & services 246 and Dynamic & Accessible Actions Management Interface 247 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store multimedia information and/or content for later publication, editing, or the like, as well as other information including address lists, contact lists, personal preferences, or the like. At least a portion of the content may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), content, and enable telecommunication with another user of another client device. Other examples of application programs include calendars, editors, email clients, IM applications, SMS applications, VOIP applications, contact managers, task managers, transcoders, database programs, word processing programs, security applications, spreadsheet programs, games, search programs, Dynamic & Accessible Actions Management application, service or interface and so forth. Applications 242 may further include browser 245. Browser 245 may include virtually any of a variety of client applications configured to receive and/or provide communications of web pages, and other content over a network. Browser 245 typically provides for a graphical display of various web pages, including user interfaces provided, in part, by another computing device over the network. Browser 245 may include a variety of security features, and/or other plug-in applications, modules, applets, scripts, or the like, to enable display of animation, videos, playing of audio files, or the like. Browser 245 and applications 242 are configured to enable a user or sender and/or receiver of Dynamic & Accessible Actions Link(s) to communicating with or search, match, select, attach, associate, one or more Dynamic & Accessible Actions Link(s) with one or more unique identifiers including mobile phone numbers based on privacy settings and preferences for sending to central server 115 of FIG. 1. Moreover, through one or more of applications 242 or Dynamic & Accessible Actions Management Application or Service or Interface 247, the user or sender and/or receiver of Dynamic & Accessible Actions Link(s) may send and/or receive Dynamic & Accessible Actions Link(s) and associate content or messages or notifications.

Illustrative Network Device Environment

FIG. 3 shows one embodiment of a network device 300, according to one embodiment of the invention. The embodiment of network device 300 illustrated in FIG. 3 may be used to implement the Dynamic & Accessible Actions server 115 or the ads server 150 of FIG. 1. Network device 300 may include many more components than those shown. It may also have less than all of those shown. The components shown, however, are sufficient to disclose an illustrative embodiment for practicing the invention. One or more network devices, and the application programs integrated with the devices, may be used to implement the processes of the present invention, as illustrated in FIGS. 4-10 and discussed herein.

In any event, network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account managers, and so forth. More detailed discussions of some application programs are included herein.

Mass memory further includes web server 356, data stores 358, and applications 350. Applications 350 are shown to include Dynamic & Accessible Actions Processor 352, Dynamic Actions associate Data Processor 354 and Social Graph, Search Engine & routing (Dynamic Actions Platform System) 355. Web server 356 includes virtually any application configured to delivers Web pages and other content to browsers and other client applications via at least the HTTP protocol. However, web server 356 may also be configured to provide scripts, user interfaces, accounting interfaces, editors, security, or the like, to the client application. Moreover, web server 356 may employ a variety of other communication protocols, beyond HTTP. For example, web server 356 may be configured to manage email communication protocols, SMS protocols, IM protocols, or the like. Moreover web server 356 may employ a variety of scripts, applets, programs, or the like, to enable communications of content with a client application.

Data stores 358 may include any of a variety of storage mechanisms, configured to store, and otherwise managed content, applications, scripts, applets, or the like. As such, data stores 358 may be a database, a file structure, or the like. Data stores 358 may store the content into a category structure, such as folders, albums, graphs, trees, or the like, based on a user account, a web service, or the like. In one embodiment, data stores 358 may represent the Data Management services illustrated in FIG. 1, and described in more detail below in conjunction with FIG. 4.

Dynamic Actions Platform 355 is described in more detail below in conjunction with FIGS. 4-10. Briefly, however, Dynamic Actions Platform 352 includes a variety of components to provide web services to a user, including Dynamic & Accessible Actions Management Interface, search tools, user interfaces, services plug-and-play modules, or the like. Various embodiments of example user interface screens are described in more detail below.

In one embodiment, applications 352 may include an Dynamic & Accessible Actions Processor 354. A Dynamic & Accessible Actions Processor may include program logic that performs actions in response to receiving Dynamic & Accessible Actions Link(s) and associate data or communication from provider(s) or sender(s) client device. These actions may include determining a set of responders including connected or related or selected users to solicit responses from, sending an Dynamic & Accessible Actions to the set of responders, or other actions relating to processing Dynamic & Accessible Action Link(s), associate referenced objects, associate data.

In one embodiment, applications 350 may include a Dynamic Actions associate Data Processor 354. A Dynamic Actions associate Data Processor may include program logic that performs actions relating to receiving and processing communications or data related to interactions of user or connected users of users with dynamic & accessible actions. These actions may include receiving and collecting responses, user interaction data, associating advertising, applying validation, spam control, limits & presentation & privacy settings, preparing a Dynamic & Accessible Action associate response to be sent to the receivers and/or provider(s), or other actions relating to processing communication and responses. These actions are discussed in further detail herein. Though FIGS. 4-10 illustrates an Social Graph, Dynamic & Accessible Actions Processor and a Dynamic Actions associate Data Processor, the actions and logic of each component may be combined into a single component, divided into multiple components in a different manner, or distributed in a variety of ways across multiple network devices.

Illustrative Operating Environment

Website and Smart Client Architecture

FIG. 4 illustrates in one embodiment social graph created based on users connections with other users based on mobile phone numbers associate with mobile device or contacts or related unique identifiers. System maintains in a database a plurality of nodes of a social graph, wherein nodes including unique identifiers including unique phone numbers of users and connected users of users, user identity, unique identifiers including unique phone numbers associate dynamic and accessible action links and associate objects and maintains in a database a plurality of connections in the social graph, where each connection represents a connection between two or more nodes in the social graph which are at least in a part created based on unique identifiers including mobile phone numbers of connected or related users of user and contact address including unique mobile phone numbers of mobile device of each user. System can also maintains in database information about one or more of the nodes and actions, transactions, communications, connections & interactions among nodes.

In one embodiment social graph is automatically created or updated based on user connections with mobile phone numbers including mobile phone numbers in contacts, incoming mobile numbers, shared or imported mobile numbers and mobile numbers presented in mobile device at any applications, lists and database. User can manually create and update social graph by searching, matching, selecting mobile phone numbers or unique user names or unique identifiers and define or selects relationships types and categories based on privacy settings, invitations and permission of owner of mobile number. User can manually input or describe information about connections among nodes of user's social graph. User can apply privacy settings for each connected nodes with user for sharing, sending, receiving one or more dynamic & accessible action link(s) and associate data.

In one embodiment present invention enable user to search, match, select, manually or auto attach or associate or identify dynamic and accessible action links with unique identifier including mobile phone number and dynamically share, publish, send and present dynamic and accessible action links with unique identifier including mobile phone number to set of viewing users including determined users based on user's connections, social graph, subscribers, match making preferences.

In one embodiment system creates and updates dynamic and accessible nodes including unique identifiers including unique phone numbers and enables users to dynamically sent, share, publish, and present dynamic and accessible nodes including accessible unique mobile phone numbers or unique user name or identity or profile object and associate dynamic and accessible action link(s) to connected or related users of user.

For example User [Yogesh Rathod] 403, having unique mobile phone number [1231231235] 403, creates contacts and enters unique mobile number [2323232434] of User [Amita Rathod] 410, system automatically identifies new phone number [2323232434] of User [Amita Rathod] 410 related to User [Yogesh Rathod] 403 and updates connection 417 information between User [Yogesh Rathod] 403 and User [Amita Rathod] 410 including that User [Yogesh Rathod] 403 connected with User [Amita Rathod] 410, privacy settings of related to each others, and plurality of other types of connection information.

In one embodiment now both users can share dynamic & accessible action links and associate data with each other based on privacy settings and permissions. In an another example when User [OPQ] 407 calls User [Yogesh Rathod] 403, system automatically updates social graph and stores information about connection between User [Yogesh Rathod] 403 and User [OPQ] 407. If User [OPQ] 407 or User [Yogesh Rathod] 403 not give permission to each other than both users cannot communicate with each other including both users cannot share dynamic & accessible action links and associate data with each others. If only User [OPQ] 407 gives part of access permission to User [Yogesh Rathod] 403 than User [Yogesh Rathod] 403 can access that part including one or more dynamic & accessible action links and associate data provided or share by User [OPQ] 407.

In an another embodiment users can access at least part of social graphs of other connected or related users up to particular numbers of degrees of separation based on privacy settings, invitations, preferences and permissions. Unique identifiers including trusted mobile phone number provide trusted identity to each node of social graph, wherein said nodes are accessible, portable and dynamically sharable with other connected or related users of user. Receiving user can access nodes including dynamic & accessible action links and participate with other users or nodes of network connected or connectable in network environment.

In another embodiment user can provide ranks and comments to each connected nodes of social graph.

In another embodiment system can automatically rank node(s) based on number of calls, total length of talks, user mediated ranks, preferences, interactions with dynamic & accessible action links including number of hits, amount of transactions and like.

In another embodiment social graph is distributed and connectable based on permission of domain or owner of social graph. A particular domain or dynamic action network or social network offers its users the ability to communicate and interact with other users of the domain or dynamic action network or social network. Users can join the dynamic action network or social network or domain and then add connections with other users, individuals and entities, to whom they desire to be connected. As used herein, the term “friend” refers to any other user to whom a user has formed a connection, association, or relationship via the website. The term “user” refers to individuals and entities (such as business, products, bands etc.) that may exist or be represented in a dynamic action network of social networking environment. Connections may be added explicitly by a user, for example, the user selecting a particular other user to be a friend, or automatically created by the dynamic action network or social networking service based on common characteristics of the users. Connections in dynamic action network or social networking services are usually in both directions, but need not be. The connection between users may be a direct connection; however, some embodiments of a dynamic action network or social networking service allow the connection to be indirect via one or more levels of connections.

Social connections are associations between a profile and a resource (or group of resources) and may include the type of the relationship (e.g. friend, colleague, spouse, likes etc) and may be either reciprocal (‘friend’) or uni-directional (following). The connection may be between different users or between a user and some social media (a video or an item the user likes). The collection of all connections of a profile is called the Social Graph of that profile.

In addition to interactions with other users, the dynamic action network or social networking service provides users with the ability to take actions on various types of items supported by the dynamic action network or social network or website. These items may include dynamic & accessible action link(s) and associate reference nodes including accessible applications, services, objects, multimedia data, groups or networks to which users of the dynamic action network or social networking service may belong, events or calendar entries in which a user might be interested, computer-based applications that a user may use via the dynamic action network or social networking service, transactions that allow users to buy or sell items via the service, and interactions with advertisements that a user may perform on or off the dynamic action network or social networking service. These are just a few examples of the items upon which a user may act on a dynamic action network or social networking service, and many others are possible. Though many of the embodiments/examples provided below are directed to a dynamic action network or social networking service, the invention described herein is not limited to a dynamic action network or social networking service, but can include other environments involving dynamic action network or social networking services, social content, or other types of websites.

User generated content on a dynamic action network or social networking service enhances the user experience of the dynamic action network or social networking service. “Content” may include any type of media content, such as dynamic & accessible action link(s), status updates or other textual messages, location information, photos, videos, and links. Content may also be posted by an authorized third-party application to a user's “communication channel,” such as a journal feed or stream. Content “items” represent single pieces of content that are represented as objects in the dynamic action network or social networking service. Using communication channels, users of a dynamic action network or social networking service increase their interaction with each other and engage with the dynamic action network or social networking service on a more frequent basis. Communication channels may comprise one or more different information delivery methods, comprising dynamic & accessible action links, or a stream, a feed, a post, an email communication, a comment on a posted content item, a mobile application, a note, a third-party application, a text message, a third-party website, an advertising communication channel, a discussion board, or any other communication channel that exists or is associated with the dynamic action network or social networking'service.

Connections, or edges, between nodes on a social graph comprise both the relationships and the interests of the nodes. On a dynamic action network or social networking service, connections may be represented by objects. Thus, as used herein, information about connections are stored as the objects representing the connections. Connections, therefore, may be “enhanced” based on interactions between the connected nodes, in one embodiment, by updating the maintained information about the connections stored as an object in a database. The maintained information may, in some embodiments, be an affinity score, or a numerical value representing the strength of connection between the two nodes. As described herein, a connection or edge may be used interchangeably with an affinity score. Thus, more information about connections may be gathered by the dynamic action network or social networking service.

In one embodiment user can filter user's social graph and access filtered social graph.

In another embodiment user can search, match, share, attach, detach, remove, block, access, and apply privacy settings, updates user's social graph.

FIG. 5 illustrates an exemplary GUI or Dynamic & Accessible Actions Management Interface 500 or 501 for User [Yogesh] 125 or 135 for managing dynamic & accessible actions on one or more unique identifiers including unique mobile phone numbers, email addresses, web site addresses. In one embodiment user can register with Dynamic & Accessible actions Server 115 for using services and applications including Dynamic & Accessible Actions Management interface with or without profile(s). Dynamic & Accessible Actions Server 115 stores 111, hosts, processes and maintains user profiles, connected users of each user or connections among users, subscribers, publications, subscriptions, user data, social graph(s), dynamic & accessible action links, dynamic & accessible action links associate profile(s), metadata, privacy settings, preferences, nodes of network(s), objects, applications, services, profile objects, groups, networks, multimedia data, lists, interfaces, use actions, binary instructions and any types of digital objects provided by providers, developers, service providers, external domains, web sites, networks, devices, databases, publishers, & advertisers (150), users, connected users of user (125, 135, 151, 152) and Dynamic & Accessible Actions Server 115 and associate user data including monitored & stored information about user & connected users interactions, actions, transactions with dynamic & accessible action links and associate objects or nodes of network(s). Dynamic & Accessible Actions Server 115 dynamically presents dynamic & accessible action link(s) at each user's interface based on senders or providers or sources and/or receiver's privacy settings, permissions and preferences and allow receiving or viewing user(s) to access said presented dynamic & accessible action link(s) associate with each unique identifiers related or connected with user or user interface or user device.

By using Dynamic & Accessible Actions Management interface user can search, match, select, attach or associate, access one or more dynamic & accessible action links with one or more unique identifiers including mobile phone numbers, email addresses, web site addresses, user name and other types of unique identifiers (describes in details in FIG. 7). User can share, synchronize, attach, detach, block, remove, update, upgrade, apply privacy settings to one or more dynamic & accessible action links of user to allow one or more connected or relate users to access said one or more dynamic & accessible action links (discuss in details in FIG. 7), presentation settings & preferences, filter, provide comments & ranks, sort, categories or lists or groups, accept requests, sent invitations to one or more selected unique identifiers and/or associate one or more dynamic & accessible action links 550. For example by using Dynamic & Accessible Actions Management interface 501 User [Yogesh] 135 can manage unique identifiers including related or connected phone numbers, email addresses, web site URLs and associate dynamic & accessible actions. When user click on own mobile phone number of [Yogesh] 505, interface presents [Yogesh] phone number associate dynamic and accessible links 508, wherein said associated dynamic and accessible links 508 presents based on dynamic and accessible links associate or attach by user, Dynamic & Accessible Actions Server, providers including developers, external domains, websites, service providers, networks, social networks, & advertisers, and connected or related or matched users of user based on invitation, request, user permission or acceptance of request or invitations. In one embodiment some of the dynamic & accessible action links are default and provided by Dynamic & Accessible Actions Server 115 or Dynamic & Accessible Actions Providers 150. User can access one or more dynamic & accessible action links associate objects, applications, services, interface, web pages, multimedia data, attachments, lists, messages, connected or connectable nodes of the network(s), connected in network environment including user & connected users profile objects, we pages, images, photos, videos, URLs, groups, networks, events, social graph, connections and like. For example User [Yogesh Rathod] clicks on unique mobile phone number of [Yogesh] 505 and clicks on default dynamic & accessible action link [My connections] and manage the connected users including search, match, find, attach, detach, remove, block, share, rank, invite one or more friends of the network and selects from suggested list of user for adding or making new connections. User [Yogesh] can access, share, manage, update user profile, and apply profile privacy settings, presentation settings & preferences by clicking or accessing [My Profile] link. User [Yogesh] can access user associated or attached one or more dynamic & accessible action links including access and share list of application installed, access, update, upgrade, purchase, and rank one or more applications from list by clicking or accessing [Applications installed] link. User [Yogesh] can access dynamic activities stream which is based on monitoring, tracking and storing user's activities or actions and presenting activity or action items with associate or attach accessible objects & connected nodes of network to user by clicking or accessing [Activities Streams] link. User [Yogesh] can access subscribed message streams of other users of network and can publish own message streams to subscribers of user by clicking or accessing [Message Streams] link. In one embodiment Dynamic Actions Server and User interface dynamically presents dynamic & accessible actions links related to advertisements, marketed products & services, applications like List of [Advertisements based on Preferences], [Try Super Game], and [Book Movie Tickets from ABC] links.

By clicking on link via keyboard or mouse or touch on links or access via voice commands or gestures or senses or via plurality of other types of link accessing methods user can invoke, open, present; access, use dynamic & accessible action link associate or referred accessible & portable one or more nodes of network or social graph connectable in network environment, applications, services, objects, web pages, websites, multimedia data, user profile object, connections, groups, networks, events, advertisements, database, list, attachments, presentation, interface, user actions, executing commands, triggering events & instructions or functions, application features, controls including windows, buttons, combo box, selection controls, tabs, visual interface, and plurality of other types of controls.

In one embodiment user can create and customize Dynamic & Accessible Actions Links including lists, groups, networks, user service, shared content items and nodes of user's social graph.

In one embodiment Dynamic & Accessible Actions Server(s) and Dynamic & Accessible Actions Provider(s) can develop, create, generate, host, stores, processes, maintains, manage, register, identify, sell, publish, provide, route, forward, update, upgrade one or more Dynamic & Accessible Action Links and/or associate reference objects or nodes or connectable or connected nodes of the network and/or associate profile(s), metadata, privacy settings, preferences, payment information, hit statistics, ranks, user data, social graph.

In one embodiment advertisers can present Dynamic & Accessible Actions Links based on user preferences, user & connected users' data and profiles, behavior, actions, activities, transactions, locations, interactions.

In one embodiment connected or related users of user can attach or associate one or more Dynamic & Accessible Actions Links with user's one or more unique identifiers including one or more unique mobile phone numbers, email addresses, user name(s), user website addresses based on user's privacy settings and permissions.

In another embodiment unique identifiers associate list of Dynamic & Accessible Actions Links can dynamically adds, updates, removes, changes based on user current location(s) or places, sensors, user actions, activities, behavior, instructions, commands, interactions, transactions, status, senses including voice, touch, vision, detection of user image in video or photo, movement, taste, smell, status, triggering of events, closeness of other mobile phones or smart devices of members of Dynamic Actions Network(s).

In another embodiment user can subscribe one or more dynamic & accessible action links based on selections of one or more sources, categories, keywords, privacy settings, rules, conditions, auto match making criteria based on preferences, user profile, user data, user actions, activities, transactions, behavior, status, triggering of events, interactions with providers profile, dynamic & accessible action links associate metadata, categories, keywords. Subscribed dynamic & accessible action links can automatically updates or user can manually selects from list of dynamic & accessible action links.

In another embodiment associating, attaching, synchronizing, updating, presenting, cloning similar dynamic & accessible action links to two or more unique identifiers of same entity or different entities on same device or different clients (online, offline, smart devices, web sites, web pages, services, smart client applications, external domains, peer to peer network application) including one or more types of unique identifiers like mobile phone numbers, email addresses, website URLs, GUID.

In one embodiment presenting unique identifier associate dynamic & accessible action links are based on user selected presentation formats and styles including list, visual, menu, tree, inline, tabular, buttons, images, page, highlighted, hover & present, and customize presentations 560. User can drag and drop and order, change position of one or more dynamic & accessible action links. User can hover on dynamic & accessible action links and can select, order, categories, organize, share, remove, attach, detach, provide ranks & comments, view help, profile & metadata, apply privacy settings & preferences, request for support, purchase, upgrade & updates dynamic & accessible action links.

In one embodiment user interface 500 or 501 presents dynamic & accessible action links associate with unique identifiers of connected or related users of user including mobile phone number(s). For example interface 500 or 501 presents User [Amita] 510 associate set of dynamic & accessible action links 513 including default dynamic & accessible action links, dynamic & accessible action links provided or set by User [Amita], Providers, advertisers, Dynamic & Accessible Actions Server and dynamic & accessible action links associated by User [Yogesh] to viewing User [Yogesh] at mobile phone device 135 of User [Yogesh] based on privacy settings, permission and preferences of User [Amita] and/or User [Yogesh]. User [Yogesh] can also attach or associate one or more dynamic & accessible action links with unique mobile phone number of User [Amita] 510 based on privacy settings, permission and acceptance of invitations or confirmations, wherein said dynamic & accessible action links presented to User [Amita] device at user interface. For example User [Yogesh] attach or associate [Send Gift] 511 dynamic & accessible action link with User[Amita]'s mobile phone number 510 with permission of User[Amita] and that [Send Gift] 511 dynamic & accessible action link presented to User [Amita]'s mobile phone device at Dynamic & Accessible Actions Management Interface 600 or 601 with label change by system i.e. [View Gift Send by Yogesh] dynamic & accessible action link 606. User [Yogesh] can access one or more dynamic & accessible action links 513 associate with User [Amita] 510 including access default dynamic & accessible action links including call or send message to User [Amita], access shared profile, access dynamic & accessible action links provided by User [Amita] including view message stream, select & listen favorite music of User [Amita], view like brands of User [Amita] and purchase one or more products & services, view photos collections of User [Amita], access activities stream of User [Amita] and participate in same activities of User [Amita], join with one or more social networks or groups of User [Amita] and use shared or partial social graph of User [Amita] for making new connections and access nodes related connection information and access dynamic & accessible action links attach by User [Yogesh] or providers or advertisers or Dynamic & Accessible Actions Server including

[Send Gift] link for sending gift to User [Amita], [Chat] link for chatting with User [Amita], [Add Amita to My Selected Network(s)] user actions for adding or inviting User [Amita] for one or more selected social networks created or managed or administrated by User [Yogesh], [Refer Deals] for sharing or presenting searched, matched, liked, purchased one or more deals to User [Amita] in [Deals] 607, [Ask Questions to Amita] link enables User [Yogesh] to ask question to User [Amita], wherein question presented to User [Amita] in [Questions] 607 for receiving answer from User [Amita] and User [Amita] can access question sent by User [Yogesh] and provide answer to User [Yogesh] by accessing [Question & Answer] application link 617.

In another embodiment user can change label of one or more dynamic & accessible action links and system can also change label of one or more dynamic & accessible action links of one or more users of Dynamic & Accessible Actions Network(s).

In another embodiment data related with one or more dynamic & accessible action links associate objects or nodes can automatically or manually synchronize to one or more other dynamic & accessible action links associate objects or nodes based on pull, push, snapshot, merge and transactions synchronization types.

In another example User [Yogesh] can dynamically access [ABC Travel] 515 associate one or more dynamic & accessible action links 518 comprising web site features, applications, and services including Call, Send Message, and Chat with [ABC Travel], Ask Tours & Travel related Questions, Book Hotel Rooms & Air Tickets and manage user profile related to ABC Travel.

In another embodiment Dynamic & Accessible Actions Server can dynamically provide, update, synchronize and publish one or more or list or categories contextual, related useful, advertised, suggested and matched unique identifiers including mobile phone numbers, landline phone numbers, user identities or names, email addresses, web site URLs with associated or attached dynamic & accessible action links based on auto math making, reference given by connected or related users of user, user preferences, survey data, user data & profile(s), user actions, activities, transactions, connections, subscriptions, selections, behavior, current location or place, triggering of events, status, interactions, and matching advertisement(s) targeting criteria with user data. In another embodiment user can search, match, select, filter, attach, allow and receives one or more unique identifiers and associate dynamic & accessible action links presented, suggested & provided by Dynamic & Accessible Actions Server, providers, external sources, advertisers, users of Dynamic & Accessible Actions Network(s), connected or related or matched users of user.

In another example User [Yogesh] can access unique website URL specific dynamic & accessible action links including [Sports Score] for real time view updated scores of selected sports event of selected sports type, [Live Video] for viewing paid or free or sponsored real-time live sports event video stream, [Book Event Tickets] link enables user to book and make payment for selected sport event tickets, [Search & Buy Sports Products & Services] for searching, selecting and buying selective sports products or subscribing proffered sports services.

In another example User [Yogesh] can access email address of User[OPQ] related dynamic & accessible action links including default call and send message dynamic & accessible action links. In another embodiment user can suggest source of unique identifier to attach one or more suggested dynamic & accessible action links with unique identifier(s).

In one embodiment present invention provides dynamic & customize user defined or system defined user actions on one or more selected unique identifiers and/or selected one or more dynamic & accessible action links. For example user [Yogesh] can select unique identifiers (505, 510, 515) and dynamic & accessible action links (511, 512) and can select and take Dynamic Customized User Actions [Share] 557 for sharing said selected unique identifiers and selected dynamic & accessible action links with one or more selected users.

In one embodiment user can share, forward, synchronize, refer, submit, publish, provide and present one or more one or more unique identifiers and/or associate dynamic & accessible action links with the permission of related provider and/or owner or source of unique identifiers and dynamic & accessible action links.

FIG. 6 illustrates an exemplary GUI or Dynamic & Accessible Actions Management Interface 600 or 601 for User [Amita] 151 or 152 for managing dynamic & accessible actions on one or more unique identifiers including unique mobile phone numbers, email addresses, web site addresses. In an example, User [Amita] 615 is connected with Users [Yogesh] 605, [Angelina] 620 and [Recipe_Worksapce] 635. User [Amita] 615 can access dynamic & accessible action links 617 associate with unique mobile 615 of User [Amita] 615. For example when User [Amita] 615 clicks on [Message. Streams] 616 dynamic & accessible action link, system presents interface 1060 to User [Amita] 615 in an integrated manner or opens in separate window or applications or web page or interface. User [Amita] 615 can view message streams, post messages to subscribers and manage one or more categories message streams. User [Yogesh] 505 or 605 is connected with User [Amita] 615 or 510. System presents [View Message Stream] link 512 at User [Yogesh] interface 500 or 501 for accessing User [Amita]'s message streams or publication of messages based on User [Yogesh] subscription of [Message Streams] 616 & 6161 of User [Amita] and/or privacy setting applied by User [Amita] fro allowing User [Yogesh] to access [Message Streams] of User [Amita].

Likewise based on User[Amita]'s privacy settings User [Yogesh] can access User [Amita]'s [Activities streams], [Favorite Music], [Like Brands], [Photo Collections], [ Social Networks], [Social Graph] 617 in user [Yogesh] interface 500 or 501 at User [Amita]'s unique identifier mobile phone number 510 associate or attached set of dynamic & accessible actions links 513 with changes of labels of links including [View Message Stream], [Listen My Favorite Music], [My Like Brands], [Amita's Photo Collections], [Amita's Activities Stream], [Amita's Social Network(s)] and [Amita's Social Graph] 513. Each User can apply privacy settings for each dynamic & accessible action link to allow one or more connected or related or matched or selected users to access said allowed dynamic & accessible action link(s) and associate multimedia data, applications, services, connections, shared profiles, objects, connected or connectable nodes of network(s), networks, groups, members of networks & groups, database, publications of one or more said users.

User [Amita] can access one or more dynamic & accessible action links associate with User [Amita]. For example when User [Amita] clicks on accessible unique identifier including mobile phone number associate with User [Amita] 615 and based on clicking on said unique mobile phone number, interface presents associate dynamic & accessible action links to User [Amita] 617. When User [Amita] clicks on [My connections] link, system presents link referenced or associate application, interface & service to User [Amita], so user can manage and access user collections and add new connections. Likewise User [Amita] can access and manage profile(s), payment information, activities streams, message streams, chat with other users, listen favorite music, list of brands likes, list of purchased, liked, referred deals, view questions of other connected or related users of network and provide answers, search deals based on search queries received, from other connected or related users, add photos to photo collections, manage social networks including add connected users to network based on acceptance of invitations, access user's social graph(s), bookmark resources, provide comments and ranks to one or more allowed nodes of networks including users, contents, sources, dynamic & accessible action links, providers of dynamic & accessible action links, brands, lists, social networks, groups, connections, publishers, advertisements, deals and plurality of other resources of networks. User can access dynamic & accessible action links attach or associate by connected or related users of user based on user permission or confirmation, Dynamic Actions Server, providers, advertisers, developers, external domains can dynamically presents dynamic & accessible action links to user based on user data and plurality of other factors discussed in specification.

Users can access one or more connected users' unique identifiers associate dynamic & accessible action links. For example User [Amita] can view gift send by User [Yogesh] (label changed by User [Amita]) via clicking on [View Gift Send by Yogesh] 606 and accessing associate interface or application, wherein User [Yogesh] manages, search, match, select, purchase, and send gift via [Send gift] link associate application 511 which is associate or attach by User [Yogesh] and authorized by User [Amita]. By clicking on dynamic & accessible action links 607 associate with user [Yogesh] 605 User [Amita] can listen music, install application that are installed by User [Yogesh], purchase deals from list of deals provided by User [Yogesh], access questions and provide answers, provide search results based on search queries sent by User [Yogesh] or read answers of User [Amita]'s questions, read reminders. In one embodiment user can attach dynamic & accessible action links with one or more unique identifiers and can access all communications or sharing done by user. For example User [Amita] can view all shared items that sent by User [Amita] to User [Yogesh] via clicking or accessing [Shared items with Yogesh] link. Likewise User [Amita] can see suggested connections and ringtones sent to User [Yoegsh].

In one embodiment Dynamic & Accessible Actions network, framework, system, service and interface facilitates users in creating, managing and accessing natural communication workflows. User or system or connected users of user or 3^{rd} parties can dynamically search, match, select, define, create, apply privacy settings, manage, and access one or more activities or types of activities and participate other connected or related or matched or selected users with activities based on privacy settings, preferences, permission, wherein activities examples includes user want to remind other users, create workflow or workspace for managing particular tasks or project, sharing travel photos, writing or authoring blogs, sharing message streams, sharing automated activities streams, send gifts at particular days, wants information related to particular locations including vegetarian restaurants, shopping malls, movie theaters, ask about brands, ask about health effect of particular fruit or vegetables and plurality types of each user associate dynamic activates, actions, interactions, relations, transactions, connections, behavior. In one embodiment if user required or defined dynamic activities associate dynamic & accessible action links and associate reference objects, applications, services is not available than user(s) can request or suggest to develop, create, enable, provide, & manage said one or more activities specific one or more dynamic & accessible action links and associate reference objects, applications, services or request to search, match and provide already available associate dynamic & accessible action links and associate reference objects, applications, and services to Dynamic & Accessible actions Server or providers or developers or connected users of user or users of network. For example user need multi city and multi cab service providers related lists, availability and cab booking via mobile device and if that service not available user can sand request Dynamic & Accessible actions Server or matched providers and developers. User request can also publish to public. So other similar types of users can send similar requests to Dynamic & Accessible actions Server or matched providers and developers.

In one embodiment user can also categories activities or dynamic & accessible action links associate with activities can presented automatically to user and connected users of user based, on user data, user actions, date, time, daily chronological timings, current locations or continuously updated location e.g. while car is moving and location is changes, places, travel or close proximity with particular persons, triggering of events, occurring of transactions, user status including determine that user is free or busy or want to entertain and like, user's interactions, purchasing of particular brand, detection of particular sense(s) by particular sensor(s), detecting or determining locations, dates & timings including finishing of movie, lunch time, arrival or departure time, finish of exams.

For example user finishing viewing of movie, mobile device associate dynamic & accessible actions interface automatically presents [Movie Review] related dynamic & accessible action link and associate interface to user, based on movie timings or sensors or any other method of detecting that movie is finished, which enables user to immediately write movie reviews and give rating to movie. In another example when user enters into particular shop of mall dynamic & accessible actions interface automatically presents dynamic & accessible action links including purchase brands, write reviews & comments, provide ranks, list and information about branded products and services to user based on user location, place, timings, preferences, privacy settings, RFID, detections of mobile identity. In another example when user enters into school system automatically presents dynamic & accessible action links including school networks links for sharing and communicating with connected users of user or members of school network(s).

In one embodiment system dynamically and automatically detects, calculates, analyze, creates, identifies, senses, infers, matches, determines and recognize based on Activity Recognition (discuss blow) user's and connected users of user's activities, actions, needs, requirements, locations, places, events, transactions, behavior, status, interactions, date & timings, distance, senses including movements, touch, and dynamically & automatically updates and presents contextual dynamic & accessible action links at prominent place of client device or interface to user(s), connected users of user, providers, 3^{rd} parties and external domains including applications, services, websites, web pages, networks, devices, databases and interfaces. Generally each user's each types of activates are dynamic, so dynamic user activities can manage by dynamically presented dynamic & accessible action links.

In an example 1040 User [Yogesh] when visits mall, system automatically detects user location & place and identifies mall associate dynamic & accessible action links based on user preferences, user data, user actions, past purchases or transactions, user profile and other plurality of factors and data and automatically presents filtered dynamic & accessible action links in unique identifier associate set of dynamic & accessible action links. For example automatically presenting to User [Yogesh] movie ticket booking dynamic & accessible action links for booking movie tickets of multiplex resides at mall, dynamically shop or order food items via mobile device, communicate with connected users or salesperson of shop or waiter of restaurant presents at mall. For example User [Yogesh] purchase two movie tickets by using dynamically presented dynamic & accessible action link [Book Movie Tickets (ABC)]. After purchasing of movie tickets successfully and when user enters into movie theatre, system automatically removes [Book Movie Tickets (ABC)] dynamic & accessible action link and presents updated dynamic & accessible action link to User[Yogesh] including [Buy Popcorn], [Buy Deals]. User [Yogesh] can order pop corn, make payment via mobile and seat numbers of User [Yogesh] automatically synchronizes to pop corn store and user gets pop corn at user's seat. After finishing of movie system may automatically detects finishing of movie based on movie timing data, sensors, users actions and system automatically presents [Real-time Movie Review] 507 to User [Yogesh]. User [Yogesh] write movie review, provide ranks, communicate with connected users of user, buy and gift liked movie tickets to one or more selected or connected or related users of user. In one embodiment system dynamically, automatically and in real-time presents dynamic & accessible action link(s) e.g. [Real-time Movie Review] 608 to connected or related or allowed users of user, e.g. User [Amita] 601 when system dynamically, automatically and in real-time presents dynamic & accessible action link(s) e.g. [Real-time Movie Review] 507 to said user e.g. User [Yoegsh] 501. So it will increases users interactions, e-commerce, user generated data or contents and user base by facilitating users & connected users of users in dynamically & automatically detecting and identifying user activities, dynamically & automatically providing or presenting activities specific user actions and dynamically connecting connected users of user for said dynamic activities and dynamic user actions for communicating, collaborating, e-commerce, sharing, dynamically create group and participating with each other.

In another example when User [Yogesh] visits bookstore at airport, system automatically presents dynamic & accessible action links at user's interface of mobile phone including [Buy Book], [Provide Comments or Reviews] and User [Yogesh] can buy two books, make payments via accessing said [Buy Book] link on user's mobile and pick one purchased books and make order for another book for shipping of books at user' address. When user exit from shop system automatically detects that User [Yogesh] buys that picked book and update inventory of books of book shop accordingly based on RFID, mobile RFID or barcode reader, online mobile payment service or mobile card reader, sensors, user's payment information, user's profile, bookstore's profile, data and location, detection of user's mobile phone location. So User [Yogesh] can directly purchase book and make payment via mobile device and physically picked purchased books from bookstore.

In one embodiment user or on behalf of user connected users of user, providers, service providers, developers, external domains, central server unit can manually or automatically 775 manage, maintain, define, create, search, match, select, filter, attach, detach, update, edit, associate, present, categories, sort, order, rank, associate metadata, profile, and maintain data including monitoring, tracking and storing data related to each entities interactions with said activities, detect, sense, identify, recognize, store, process one or more activities or actions including defined, auto identified or detected or sensed or inferred or recognized, user created, edited, updated, current, prospective, suggested, liked, determined, connected, related, contextual, undefined, excluded, blocked, removed, detached, past, present, future, presented, selected, inferred, transformed, possible in near future activities (e.g. “User is entering or entered into particular mall”, “User want to buy particular products & services”, “I am currently playing games on ipad”, “Now user's current location is New York City”, “Do you like or want to eat ABC ice creams”, “I suggest you to visit YYY mall”, “User want to buy mobile”, “User is buying mobile”, “User purchased mobile”, “User is using mobile”) and manually or automatically and dynamically 715, 713 & 710 (describe above in details) search, auto or manually match and determine based on user privacy settings, preference, user inputs including details, commands, rules, instructions, selections, user data, user profile, user interacted or participants data and activity type metadata, select, filter, attach, detach, associate, purchase, order customized, select template and select or edit or update or customize from template or tags; select from suggested or auto match list provided by connected users of user including friends, friends of friends, part of social graph, providers, service providers, external domains, and central server unit, one or more dynamic & accessible action links, wherein said dynamic & accessible action links enables or facilitates user or participants or related users or entities to communicate, collaborate, transact, take one or more dynamic actions, share, participates, achieve activities, fulfill activities related one or more tasks, workflows, procedures, targets, goals and transactions. Present invention is not limited to above mentioned activities and associate dynamic actions. There are plurality of ways to identify and define plurality types of user activities for plurality of different users and plurality of ways to search, select, identify, determine, auto match, and present plurality of dynamic & accessible actions on each said activities of plurality types of activities without departing from the spirit of the invention. Present invention can implemented throughout the world and can enable plurality types of dynamic actions on plurality types of activities of plurality types of users.

Each activity associate said metadata and data comprises activity profile, activity type, activity name or label, activity identity & URL, public or private activity type, activity structured or unstructured details, author of activity, actor identity & profile, one or more participants identity & profiles, date & timings, locations, activity associate one or more dynamic & accessible action links and associate referenced one or more applications, services, objects, connectable or connected nodes of network connected in network environment, multimedia data, user actions, dynamic application features, interface, controls, instructions, commands, rules, networks, groups, lists, attachments, messages, connection & profile objects and databases, details of acting on activities including user's and connected users' or participants' interactions, actions, transactions, behavior associate with activity, status of activity, privacy settings, preferences, rules, conditions, categories, keywords associate with activity, similar or alternative activities, similar types of activities related matched data, payment & transaction information, related part of social graph.

Activity Recognition: Activity recognition aims to recognize the actions and goals of one or more agents from a series of observations on the agents' actions and the environmental conditions. To understand activity recognition better, consider the following scenario. An elderly man wakes up at dawn in his small studio apartment, where he stays alone. He lights the stove to make a pot of tea, switches on the toaster oven, and takes some bread and jelly from the cupboard. After taking his morning medication, a computer-generated voice gently reminds him to turn off the toaster. Later that day, his daughter accesses a secure website where she scans a check-list, which was created by a sensor network in her father's apartment. She finds that her father is eating normally, taking his medicine on schedule, and continuing to manage his daily life on his own. That information puts her mind at ease. Due to its many-faceted nature, different fields may refer to activity recognition as plan recognition, goal recognition, intent recognition, behavior recognition, location estimation and location-based services.

Physical activities, actions, status of user or any types of entities further comprising plurality of fields, metadata, data including weight, size, height, time, duration, length, condition, status, heat, motion, Light, motion, temperature, magnetic fields, gravity, humidity, vibration, pressure, electrical fields, sound, and other physical aspects of the external environment, Physical aspects of the internal environment, such as stretch, motion of the organism, and position of appendages, Environmental molecules, including toxins, nutrients, and pheromones, Estimation of bimolecular interaction and some kinetics parameters, Internal metabolic milieu, such as glucose level, oxygen level, Internal signal molecules, such as hormones, neurotransmitters, and cytokines.

Types of Activity Recognition

Sensor-based, single-user activity recognition: Sensor-based activity recognition integrates the emerging area of sensor networks with novel data mining and machine learning techniques to model a wide range of human activities. Mobile devices (e.g. smart phones) provide sufficient sensor data and calculation power to enable physical activity recognition to provide an estimation of the energy consumption during everyday life. Sensor-based activity recognition researchers believe that by empowering ubiquitous computers and sensors to monitor the behavior of agents (under consent), these computers will be better suited to act on our behalf.

Levels of sensor-based activity recognition: Sensor-based activity recognition is a challenging task due to the inherent noisy nature of the input. Thus, statistical modeling has been the main thrust in this direction in layers, where the recognition at several intermediate levels is conducted and connected. At the lowest level where the sensor data are collected, statistical learning concerns how to find the detailed locations of agents from the received signal data. At an intermediate level, statistical inference may be concerned about how to recognize individuals' activities from the inferred location sequences and environmental conditions at the lower levels. Furthermore, at the highest level a major concern is to find out the overall goal or sub goals of an agent from the activity sequences through a mixture of logical and statistical reasoning.

Sensor-based, multi-user activity recognition: Recognizing activities for multiple users using on-body sensors. Other sensor technology such as acceleration sensors were used for identifying group activity patterns during office scenarios.

Vision-based activity recognition: It is a very important and challenging problem to track and understand the behavior of agents through videos taken by various cameras. The primary technique employed is computer vision. Vision-based activity recognition has found many applications such as human-computer interaction, user interface design, robot learning, and surveillance, among others.

In vision-based activity recognition, a great deal of work has been done. Researchers have attempted a number of methods such as optical flow, Kalman filtering, hidden Markov models, etc., under different modalities such as single camera, stereo, and infrared. In addition, researchers have considered multiple aspects on this topic, including single pedestrian tracking, group tracking, and detecting dropped objects.

Levels of vision-based activity recognition: In vision-based activity recognition, the computational process is often divided into four steps, namely human detection, human tracking, human activity recognition and then a high-level activity evaluation

Approaches of Activity Recognition:

Recognition through logic and reasoning: Logic-based approaches keep track of all logically consistent explanations of the observed actions. Thus, all possible and consistent plans or goals must be considered.

Activity recognition through probabilistic reasoning: Probability theory and statistical learning models are more recently applied in activity recognition to reason about actions, plans and goals.

Wi-Fi-based activity recognition

Data mining based approach to activity recognition

Plurality of physical action or activities recognition algorithm, research, systems, method, devise can apply or use or employ for identifying, recognizing various types of user or any entities including human, non-human, building, tree, device, machine, bird, group of humans related actions, status, environment, conditions, logs, transactions, events, interactions, and activities including human related like edits, touches, senses, motion, hear, view or see something, taste, experience, environment, reads, eat, drink, like, drive, walk, talk, think, feel, breathe, performance, interaction with people, object or anything, user status & conditions, attention, pick something, running, standing, setting, shopping, doing housework, dancing, singing, jump, fall, preparing dinner & lunch, listing to music, taking medications, watching, washing, bathing, dressing, cleaning, sleeping, resting, buying, selling and plurality of other human or group of humans or environment of human actions, activities, status.

Wireless sensor network (WSN) consists of spatially distributed autonomous sensors to monitor physical or environmental conditions, such as temperature, sound, vibration, pressure, motion or pollutants and to cooperatively pass their data through the network to a main location. The more modern networks are bi-directional, enabling also to control the activity of the sensors. Applications of wireless sensor network (WSN) are Area monitoring, Environmental. monitoring, Air pollution monitoring, Forest fires detection, Greenhouse monitoring, Landslide detection, Industrial monitoring like Machine health monitoring, Water/wastewater monitoring, Landfill ground well level monitoring and pump counter, Fleet monitoring

In one embodiment publisher's or user's subscribers can access one or more related dynamic & accessible action links, wherein said dynamic & accessible action links enables subscribers or receivers or viewing users to access subscribed publications, messages, categories message streams, shared contents, shared profiles, shared lists, user services, activities streams and plurality types of sharing, publishing, communications.

In one embodiment user can post one or more dynamic & accessible action links based on selection from categories list(s) of dynamic & accessible action links, entering name or reference URL of dynamic & accessible action links, select from auto matched list(s) of dynamic & accessible action links, select unique identifiers and select from list of associate dynamic & accessible action links to one or more users of networks and selected or connected or related users of user, subscribers, preference based matched users, travel user's social graph up to particular number of depth or degrees of separations.

In one embodiment user can search dynamic & accessible action links based on one or more unique identifiers, user name, connected users of user names, user profile data, search queries, keywords, name or URL of dynamic & accessible action links, data associate with dynamic & accessible action links, providers name or URLs, categories of unique identifiers and/or dynamic & accessible action links, conditions, rules, locations.

In one embodiment Dynamic & Accessible Action Server or user can share, publish, update, and synchronize dynamic & accessible action links and associate user contents with one or more external domains, web sites, database, devices, networks, groups, applications and services.

In one embodiment users of Dynamic & Accessible Action Network(s) can login from external domains and connect with Dynamic & Accessible Action Network(s) and users, dynamic & accessible action links associate applications, connectable nodes of network & objects of Dynamic & Accessible Action Network(s) and can share contents, sent messages, automated monitored user actions or activities stream with action item associate accessible objects, provide user services, communicate, collaborate and participate with connected or related users of user.

FIG. 7 illustrates an exemplary GUI for enabling user to search, match, select, filter, update, purchase one or more dynamic & accessible action links and attach one or more selected dynamic & accessible action links with one or more selected unique identifiers. User can also detach, remove, block, further attach, share one or more dynamic & accessible action links associate with one or more unique identifiers. User is enabled to apply privacy settings to one or more dynamic & accessible action links for allowing one or more selected users to access said dynamic & accessible action links, associate user data, shared user profiles, user connections, metadata, preferences, privacy settings and communicate with user based on said allowed dynamic & accessible action links and privacy settings and preferences of receiving users.

In an example User [Yogesh] 135 selects or clicks on user's own unique mobile phone number 705 for attaching or associate one or more dynamic & accessible action links via searching, matching, filtering, selecting and attaching or associating one or more dynamic & accessible action links from categories list(s) of dynamic & accessible action links 713, wherein said one or more selectable categories list(s) dynamic & accessible action links of are presented based on user's search queries, match making preferences, one or more filters including source or providers name, locations, categories, paid or free types, rank and other filter criteria, selecting specific types of dynamic & accessible action links 715 including default or system or Dynamic & Accessible Action Server provided dynamic & accessible action links, provider specific, categories activities specific, purchased or subscribed, dynamic & accessible action links related or connected or related users of user, dynamic & accessible action links suggested by Dynamic & Accessible Action Server, connected users of user, advertisers, providers, 3^{rd} parties or external domains and matched users of network or auto matched dynamic & accessible action links based on user data, profile, privacy settings, preferences, activities, actions, interactions, status, behavior, locations, and transactions, Categories list or directories of dynamic & accessible action links, bookmarked dynamic & accessible action links, invited, shared, user created and search result specific dynamic & accessible action links, dynamic & accessible action links related to particular types applications, services, multimedia data types, objects, networks, groups, database, lists. 710 shows user attached or associate dynamic & accessible action links, where user can further search, attach, detach, associated with one or more defined, created, selected, matched, current, auto identified or detected or sensed or recognize, shared, suggested, participated, associated activities and select one or more dynamic & accessible action links and apply privacy settings 720 for each attached or associated and selected dynamic & accessible action link(s) 710 for enabling one or more selected users 723 to allow to access said dynamic & accessible action link(s) 710 and enables them to view & access user's shared contents, communicate, collaborate, share, publish, and participate with user's activities (FIGS. 5 & 6). For example User [Yogesh] 135 selects dynamic & accessible action links including [View Message Stream] and [View Activities Feed] 710 and apply privacy settings via list of privacy settings selections 720 including allow everyone, allow all networks and friends of friends or members, allow only to friends of friends, allow only to user's connected users or friends, allow only to members of networks, allow only selected networks and/or friends and/or friends of friends and/or members of network(s) and/or selected unique identifiers including unique mobile phone numbers, email addresses, website URLs, one or more types or categories or keyword specific activities related or matched or connected one or more users, one or more selected or all subscribers or bookmarked, selected one or more or part of groups or categories lists or allow only to results of search queries, keywords, categories, conditions, filters, auto matchmaking preferences specific users, friends, friends of friends, members and networks to access said selected dynamic & accessible action links. User can individually search, match, filter, select users from list 723, which are presented based on user selection of types of privacy settings and selection of one more networks, groups, lists, categories, auto group 720. In one embodiment user can select one or more friends, users of networks, friends of friends, members, lists, unique identifiers for excluding to allow to access one or more said selected dynamic & accessible action links 710. In one embodiment user can invite one or more users including connected or related users of user and selected unique identifiers for acceptance of allowable dynamic & accessible action links by receiving user. In one embodiment user can accept requests of one or more other users to allow receiving their dynamic & accessible action links at user's interface.

In one embodiment user can attach or associate dynamic & accessible action links with one or more selected unique identifiers. For example User [Yogesh] 135 associates searched, matched, filtered, purchased & selected 733 dynamic & accessible action links including [Send Gift] and [Chat] 727 with permission of User [Amita] with unique identifier i.e. mobile phone number of User [Amita] 725. User can further search, attach, detach, apply privacy settings for restricting sharing of certain types, categories, keywords related contents, setting date & time ranges for availability or access, number of times use, duration of use, restrict re-share or forward rights or re-share or republish with the permission of user, restrict participation of other users or excluded users, and apply plurality of other types of privacy settings and preferences with one or more dynamic & accessible action links.

In one embodiment user can take one or more user actions on one or more selected or group(s) of unique identifiers including mobile number(s), email addresses, website URLs including search, match, filter, sort, remove, block, attach, detach, categories, share, synchronize associate dynamic & accessible action links and/or associate user data and/or associate profile, update, publish, rank, provide comments & descriptions, bookmark, add or update photos or profile, view information, apply privacy settings for allow limited access to one or more connected users or receivers or subscribers and plurality of dynamic and customized user or system defined or created user actions.

In one embodiment user can connect smart device including mobile phone with personal computers, digital television, laptops, web sites, smart client applications, applications, services, devices, databases, networks, remote devices and other smart devices and can access, manage, search, purchase, apply privacy settings, backups, clone, synchronize, downloads, uploads, upgrades and updates Dynamic & Accessible Action Interface or applications or services or APIs or Frameworks, Dynamic & Accessible Action network(s) and Dynamic & Accessible Action Server. In another embodiment user can access extended Dynamic & Accessible Action Interface or applications or services on more power full smart devices for taking advantages of their capabilities including fast processor, more memory, fast speed of internet connections, large size of screen, powerful and full features operating systems, attached plug-n-play devices including USB, memory, keyboards and like. In one embodiment user can search, match, select, purchase, subscribe, download, update dynamic & accessible action links and/or associate applications, services, objects, database, interfaces from website(s) or smart client applications including web site of Dynamic & Accessible Action network(s) and providers websites and then synchronize to mobile device. In another embodiment Dynamic & Accessible Action Server hosts, stores, maintains, manages providers' dynamic & accessible action links and associate applications, services, databases, profiles, indexes, user data, user profiles, privacy settings, preferences, metadata, websites, objects, nodes, multimedia data, provide central search engine, provide APIs for developing, integrating application and services, downloading, updating, upgrading, customer support, online subscription, registration, ranking, commenting, verification, payment and e-commerce services to customer of providers for purchasing applications, subscribing services, multimedia contents and databases including games, social network, travels, magazines, news, stocks, finance, education, yellow pages, health, search, e-commerce related applications & services and enterprise applications.

In one embodiment user can imports or exports contacts and unique identifiers including mobile phone numbers, email addresses, website URLs, user connections, compatible or updatable dynamic & accessible action links, user profile and data from/to one or more sources, applications, services, devices, databases, multimedia data, networks and devices.

In one embodiment one or more Dynamic & Accessible Action networks can collaboratively communicate, integrate with each others based on permissions and privacy settings. Users of one or more Dynamic & Accessible Action networks can access and share dynamic & accessible action links Dynamic & Accessible Action networks.

In one embodiment dynamic & accessible action links can be in the form of text link, image or icon link, visual, multimedia data, control including buttons, tabs, menus, lists, tress.

In one embodiment providers can register with Dynamic & Accessible Actions Server or Network or Framework for providing, selling, verifying, validating, registering, hosting, storing, maintaining, managing, processing, publishing, providing support services, upgrade & updates services, and making searchable downloadable one or more dynamic & accessible action links and associate applications, services, objects, databases, lists, networks, groups, interfaces, multimedia data, and dynamic activities specific applications, services, commands, programming instructions, user actions.

In another embodiment developers, providers, advertisers, source of dynamic & accessible action links and associate applications, services, objects, databases, lists, networks, groups, interfaces, multimedia data, and dynamic activities specific applications, services, commands, programming instructions, user actions can register with Dynamic & Accessible Actions Server or Network or Framework and can maintain, host, store, manage, process, publish, provide support services, upgrade & updates services from different server(s). Dynamic & Accessible Actions Server or Network can maintain only information about dynamic & accessible action links for making them searchable, enable selling or e-commerce of dynamic & accessible action links of providers. User can download dynamic & accessible action links and/or associate applications, services, objects, databases, lists, networks, groups, interfaces, multimedia data, and dynamic activities specific applications, services, commands, programming instructions, dynamic user actions from provider server with some mediation of Dynamic & Accessible Actions Server or Network(s).

In one embodiment providing interface to providers, developers, advertisers, creator users of dynamic & accessible action links for creating, generating, assigning, developing dynamic & accessible action links and associating metadata, reference link of one or more applications, services, objects, databases, lists, networks, groups, interfaces, multimedia data, and dynamic activities specific applications, services, commands, programming instructions, user actions, controls including menus, windows, lists, combo box and like, associate metadata, update profile, privacy settings, preferences, authentication information. In another embodiment Dynamic & Accessible Actions Server can creates dynamic & accessible action links on behalf of developers, providers, advertisers.

In one embodiment Dynamic & Accessible Actions Server provides search engine to user for searching, matching, view details including description of products & services, comments, ranks, and reviews, select one or more dynamic & accessible action links and/or associate applications, services, objects, databases, lists, networks, groups, interfaces, multimedia data, and dynamic activities specific applications, services, commands, programming instructions, user actions, controls including menus, windows, lists, combo box and like and can buy, try, download, subscribe, register with provider, update profile and payment information, request for support, updates and updates, provide comments, ranks and suggestions, request for developing dynamic user activities or actions specific applications, services, databases, networks, groups, devices, multimedia data, widgets, interfaces and like.

In one embodiment user can merge two or more selected, matched, filtered or all unique identifiers and/or associate one or more selected or filtered or all dynamic & accessible action links and/or associate data.

FIG. 8 illustrates an exemplary GUI showing example that when User [Yogesh] click on user attached or dynamically presented [Book Movie Tickets from ABC] link, system presents [Book Movie Tickets from ABC] link associate application or interface or web page or service interface 850 which enables user to buy movie tickets and make payment in an integrated, customize, unified manner. User can also refer movie to other connected users or user can ask and confirm from one or more connected users for viewing movie and buying of movie tickets collaboratively. User can book all tickets and paid from user accounts or system can deduct amount of each movie ticket from each user's account. Dynamic & Accessible Action server stores interactions of user with one or more dynamic & accessible action links and/or associate applications, objects, connected nodes of network(s) & services. In another example User [Yogesh] subscribe for live sports events and view subscribed live sports events via accessing or clicking [Live Video]. User can refer to other connected users via mobile device, real-time provide live comments on particular scene or views or image(s) and/or during time or time range of video to one or more connected users of users or publish for all users of network(s) or external domains.

FIG. 9 illustrates an exemplary GUI showing example that when User [Amita] click on user attached or dynamically presented [Social Networks] 930, system presents [Social Networks] 930 link associate menu or application or interface or web page or service interface 850 which enables user to create and manage social networks & associate members or connections, invite one or more selected or connected or related users of user for join to user's one or more social network(s), share contents with members of social networks and manage profile(s) 940. In another example when User [Amita] click on user attached or dynamically presented [Fashion Deals] 945, system presents [Fashion Deals] 945 link associate list of child dynamic & accessible action links or menu (not shown in figure). For example User [Amita] clicks on child dynamic & accessible action link [Search Fashion Deals] from list of child dynamic & accessible action links, system presents search engine interface 950 to User [Amita] for searching deals. User [Amita] searches fashion related deals in New York City and buys selected deals via further presented interface or application or web page or service interface 960. Central server unit monitors, records, tracks, stores, maintains, shares and processes user's interactions, actions, transactions, status, locations, associate with one or more dynamic & accessible action links and/or associate references applications, connected nodes of network(S), objects, services, databases and share with user, connected users of users, providers, external domains and public based on privacy settings & preferences of user, one or more connected users of user, providers, external domains and Dynamic & Accessible Server.

FIG. 10 illustrates various exemplary GUI showing examples including interface or list or application 1010 related to [Activities Streams] link 560 of User [Yogesh] 135 of dynamic & Accessible Network 115, which is presented to User [Yogesh] with unique identifier associate [Activities Streams] dynamic & accessible action link 560 as well as to allowed User [Amita] with unique identifier associate [Activities Streams] dynamic & accessible action link 617 based on privacy settings and permission. Both users can real time see each other's activities and participate, share, transact, communicate and collaborate with each other. In another example User [Amita] can ask question(s) to one or more connected or related or matched users of network by using [Questions & Answers] application 1050 invoke or open or enable via clicking or accessing dynamic & accessible action link [Question & Answer] 618 or can ask question to specific user e.g. User [Amita] can ask question to User [Yogesh] via accessing User [Yogesh] associate dynamic & accessible action link [Questions] 619 and User [Yogesh] can provide answer of question of User [Amita] via dynamic & accessible action link [Provide Answer to Amita] 565. Dynamic & Accessible Action Server can stores instructions of user's and connected users of user with said dynamic & accessible action and stores questions and answers of each user and making them searchable for other users based on privacy settings of users.

FIG. 11 illustrates various examples related to user's various dynamic activities including prospective activities, user defined, inputted, searched, matched, filtered, categories, bookmarked, imported, shared, ranked, selected & attached activities, connected users of user's activities, public activates published by users of network, auto matched, auto identified, auto sensed & auto detected activities, suggested, inferred, mined, provided, authored, searched, matched, selected & defined on behalf of user activities by central server, connected users of user, related users of network, friends, friends of friends, external domains, web sites, applications, services, networks, databases, devices & service providers, developers, & advertisers, invited, requested & participated activities, group activities including dynamic grouping based on location, place, date & time, event, activities related to workflow, workspace, & collaborations, orchestrated activities, activities presented based on connected users of user's profile & user data, preferences, privacy settings, user connections, user's activities, actions, interactions, transactions, connections, participations, events, behavior from one or more domains, networks, smart devices, sensors, sensor networks, web sites, applications, physical locations & places, recorded and monitored logs including phone calls, emails, message streams, activities streams, searching, talking, viewing or watching and like, current location, place & data & time, status, communications, collaborations, activities presented based on real time and on demand wizards, categories survey forms, questionnaires, data mining, applying artificial intelligence & inferences, selections, details provided by user, connected users of user, service providers, 3^{rd} parties or external domains, developers, advertisers. Various examples 1115 including in a example where system automatically detected near location of connected. User [Amita] and User [Angelina] of User [Yogesh] and presenting contextual and suggested dynamic & accessible actions to user [Yogesh]. In another example when user [Yogesh] searching “New York Travels” keyword at external domains system monitors, tracks user's searching activities or actions and present said searching activity or action specific contextual and suggested dynamic & accessible actions including “ask question” to expert related to or preferably “New York Travels”, invite other connected or related or auto matched online available users of one or more domains or networks to collaboratively search “New York Travels” keywords and book air tickets. In another examples system infers and presents various activities and associate dynamic & accessible action links based on user's and connected users' data mining, auto match making, tracking and applying artificial intelligence. For example user [Yogesh] when ask question related to “hotels in NYC” via application or web site, system monitors, tracks, detects, senses and identifies user's actions from said application and present dynamic activities and associate dynamic & accessible action links.

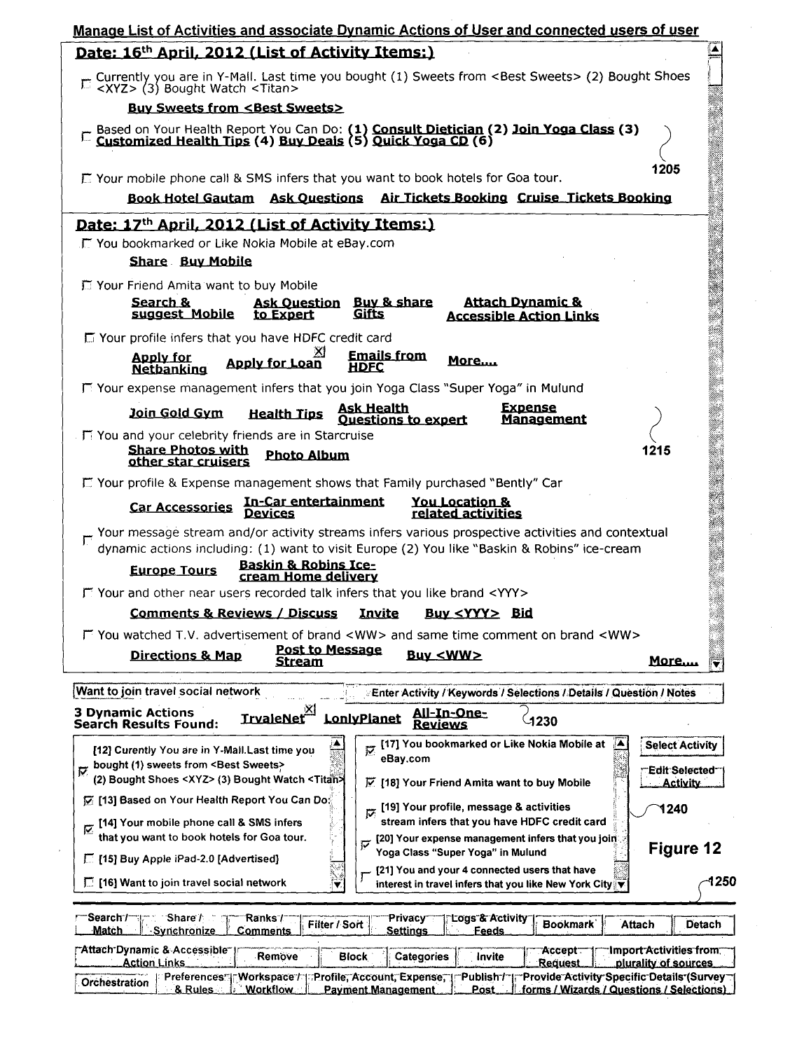

FIG. 12 illustrates various examples related to user's various dynamic activities including present activities and associate dynamic & accessible action links based on historical user activities and actions, user's data including health reports, recorded user's phone calls and SMS messages, user generated contents, user's actions at 3^{rd} parties or external web sites, connected users of user's activities and invitations, user's various applications, sensors, smart devices, networks, connections, behavior, interactions, databases, message streams, life streams, and activates streams and any combination thereof. So there are pluralities of ways to present activities and associate dynamic & accessible actions related to user and connected users of user. In one embodiment user can send, post, publish, integrate, access, store, maintain, manage, process, receive, share, and synchronize one or more activities and associate dynamic & accessible links to/from one or more communication channels including emails, IM, message stream, activity streams, web sites, application, services, devices, databases, networks, profiles, external domains.

In one embodiment 1150 shows that user can take one or more actions on one or more activities and/or one or more activities associate or attach or related one or more dynamic & accessible actions including search, match, select, attach, detach, share, synchronize, rank, provide comments, filter, sort, apply privacy settings & preferences, bookmark, attach one or more dynamic & accessible actions with one or more activities, remove, block, categories, invite for joining user activities, accept request and allow to join one or more requestor or connected or related users of user. In one embodiment User can import activities from one or more sources including external domains, web sites, profiles, devices, databases, networks, lists, directories, applications, services, contacts, saved search results, activities of connected users of user, templates, tags, wizards. In one embodiment system stores or monitors or tracks information about user's interaction with activities and associate or attached dynamic & accessible actions In one embodiment User and connected user's of user can view and access logs of user activities and actions. In one embodiment User can create one or more workspaces and workflows and attach, detach one or more activities, invite one or more participants with each workflow and workspace. User can orchestrate plurality of activities related to plurality of or series or sequence of tasks, workflows, related to user's timelines. In one embodiment user can publicly post one or more activities and invite them to participate and provide one or more dynamic & accessible actions on said one or more public activities of user. In one embodiment system dynamically, real time and on demand present categories survey forms, questionnaires, wizards, selection interface for receiving details from user and based on said details provided by user present contextual activities and associate dynamic & accessible actions. In one embodiment user can manage activities related profile, user data, payment information, expense management and user accounts. 1140 In one embodiment user can select, attach, detach, search, match, share, sort, filter, rank, remove, block, categories, bookmark, edit and update one or more presented activities and attach or associate one or more dynamic & accessible action links.

In another embodiment user can create and update calendar associate activities & associate dynamic & accessible action links and schedule presenting of activities & associate dynamic & accessible action links to user, selective connected users of user, one or more communication channels, applications, services, web sites, web pages, databases, profiles, smart devices, networks.

In another embodiment user can select, search, match, edit, update, attach, detach, rank, remove, filter, categories and sort one or more or series of, sequence of, chronological, as per time, date, categories and timeline one or more activities and associate one or more dynamic & accessible action links from templates or tags.

In another embodiment user can synchronize various activities, associate dynamic & accessible action links, associate user interaction data from one or more sources to one or more destinations, wherein said source and destination each comprising one or more connected user of user, web sites, applications, services, domains, profiles, web pages, networks, groups, smart devices, databases, interfaces.

In another embodiment system dynamically presents and updates one or more activities and each activity associate one or more dynamic & accessible action links while pre occurring of activities, during doing of activities and activities finished.

In another embodiment users, providers, developers, central server or system are enabled to programming series or sequence of activities and associate one or more dynamic & accessible action links based on conditions, criteria, rules, privacy settings, preferences, programming language syntax, commands, keywords, categories, types, date & time ranges, Boolean operators, business logic, user selections & parameters, queries, SQL, scripting languages, user data and connected users' data including structured and unstructured databases & attributes of profile, user connections, related events, event types, actions, action types, transactions, transaction types, senses types, location names, connectable and identified accessible nodes of network(s) connectable in network environment including list of identified or predefined activities and dynamic & accessible action links and associate referenced applications, services, user actions, profile objects, connection objects, lists, objects, networks, groups, events, multimedia data, commands via programming languages, rule base language, web services, APIs, and binary instructions. For example central server author customized programming for user [Yogesh] including If User [Yogesh] ANS/OR User [Amita] is in Location or Place [Y-Mall] than Present Dynamic Actions [“Search Gift”, “Buy Movie Tickets”, “Present Survey Forms”, “Provide Mall Shopping Directories”], wherein said instruction executes when User [Yogesh enter in to [Y-Mall] and system dynamically presents customized dynamic & accessible said links at user [Yogesh] device or application or web page. In another example service provider author programming for customers including If transaction amount >=$ 500 than present and add [Discount Coupon or Cumulative points to customer] at user's device. So interface can present dynamic, customized, contextual one or more or series or chronological or sequence of activities and associate dynamic & accessible action links as per user, connected users of user, task, workflow, location, user types, user profile, activity or action type, date & time, events, conditions, and rules. In another example “If Shop Inventory is less than 100 units than present [Order Product, Call for give order]”. In another example “If User [Yogesh] say or speak [”Like“] than present [1 Free Coupon]”.

In one embodiment present user's one or more activity related one or more other similar, alternative, suggested, ranked, and prospective next activities of user and connected users of user to user based on activities related keywords, categories, user profile & user data.

In one embodiment present user's one or more activity related one or more similar, alternative, suggested, ranked and next prospective dynamic & accessible actions links.

In one embodiment dynamically create grouping based on one or more connected or related users' one or more activities and/or on one or more connected or related users' one or more activities associate dynamic & accessible action links. One or more user can administrate the one or more dynamic groups and can invite and attach one or more members or users of network including connected or related users of user. Administrator(s) can dynamically attach one or more additional activities and one or more additional dynamic & accessible action links with one or more activities of one or more dynamic groups.

In one embodiment user can refer one or more activities and associate one or more dynamic & accessible action links to one or more other users of networks including connected users, friends, and friends of friends, matched or like minded users.

In one embodiment enable user to register, access and receive one or more activities and one or more dynamic & accessible action links and/or associate referenced application, service, network, group, user action, object, database, list, interface based on URL.

In one embodiment register domain and subject specific expert activities & actions service providers 150 including advertisers, users, developers and providers with dynamic & accessible action server(s) 115 with profile(s) and enable users of dynamic & accessible action network(s) to register with said one or more service providers, wherein said activities & actions service providers provide one or more domain or subject or categories specific activities and dynamic & accessible action links to users or subscribers based on plurality of criteria discuss throughout the specification. In one embodiment said activities & actions service providers can develop, create, reregister, verify, validate, manage, store, host, maintain, process, share, publish, making searchable, sell, provide update, upgrades & support, suggest, synchronize, and manage one or more activities and associate dynamic & accessible action links and referenced applications, services, objects, social networks, groups, profiles, multimedia data, databases, interface, controls, user actions, binary instructions and plurality of other types of objects. User can search, match, filter, select, sort, bookmark, rank, provide comments, categories, subscribe, register, purchase, download, update, upgrade, apply privacy settings & customize settings and receive one or more activities and one or more dynamic & accessible action links and activities related services including multimedia data, contents, human mediated services, applications, objects, instructions, answers, directions, consultations, suggestions, reviews, yellow pages or directories, search results, match making, facilitating in workflow, assigned task(s) fulfillment including ticket bookings, hotel rooms reservations, and comparison analysis and plurality types of services.

In one embodiment advertisers and/or service providers and/or central server or dynamic & accessible action server(s) can advertise, host, store, process, register, manage, update, upgrade, present, provide one or more advertisements related one or more activities and associate one or more dynamic & accessible action links and target to users based on matching advertisement targeting criteria including keywords, categories, products & services descriptions, location, and plurality of other criteria with user's & connected users of user's profile, user data, preferences, privacy settings, location(s), actions, senses, events, behavior, past transactions, interactions with advertised products, services, interactions with smart devices including touch screen, RFID, voice enabled technologies, sensors and location of place & shop of advertised products and services and dynamically suggest, and present advertised products & services related contextual activities and associate contextual dynamic & accessible action links. For example 1205 when User [Yogesh] entered in to Y-Mall, User [Yogesh] is presented with advertised activity related to Y-Mall including “Currently you are in Y-Mall. Last time you bought (1) Sweets from <Best Sweets>, <Taste Sweets>(2) Bought Shoes <XYZ>, <Free Magazine for You> (3) Bought Watch <Titan>, <Free Gifts for You>, wherein said accessible link enables User [Yogesh] to further buy, taste, experiment, discover, search, look said products and services and shop or alternative available products & services from respective sellers. In one embodiment by using advertised activities and associate dynamic & accessible action links users can buy, subscribe, bid, review, taste, trial, order, experiment products & services, gets free gifts and coupons, ask question or discuss with advertisers or sales persons, get shop directions & map, provide ranks, comments & reviews, refer products & services to connected users of user, collaboratively buy or subscribe products & services, negotiate with seller, gets discounted deals, trial applications, listen music, get sample.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

1. A method to enable dynamically displaying dynamic and accessible action links with one or more unique identifiers including unique smart phone or mobile phone number(s) and activities.

2. A method according to claim 1, wherein creating and updating social graphs of network based on list of unique identifier or unique identifiers associate with user devices including unique identifiers associate with user, connected or related users of user, friends, friends of friends.

3. A method according to claim 1, wherein registering user or mobile phone, assigning unique identity and Uniform Resource Locator (URL) and maintaining and storing profile, preferences, privacy settings, each unique identifier & activity associate dynamic & accessible action links and associate applications, services, objects and connected nodes of the network(s) connectable in network environment, payment information, connections among users, wherein connections based on mobile phone contacts, mobile social graph, social network, incoming phone numbers of mobile and unique identifiers associated with mobiles or smart devices.

4. A method according to claim 1, wherein unique identifier including unique phone number, mobile number, email address, IM credentials, URL, links, namespace, URI, IP address, Unique user name, GUID, location, place, activities, actions, keywords, categories and plurality types of unique identifiers.

5. A method according to claim 1, wherein allowing users to search, match, select, manually or auto attach or associate dynamic and accessible action links with one or more searched, matched, selected unique identifiers and activities.

6. A method according to claim 1, wherein search, match, select, manually or auto attach or associate dynamic and accessible action links with one or more searched, matched, selected unique identifiers or activities including unique identifiers or activities of user, connected users of user, lists, networks, members, friends, friends of friends based on privacy settings, permissions, preferences, acceptance of invitations of one or more connected users of user or owner(s) of mobile phone number(s).

7. A method according to claim 1, wherein allowing users, service providers, advertisers to search, match, select, manually or auto attach or associate dynamic and accessible action links with one or more searched, matched, selected unique identifiers or activities including unique identifiers or activities of one or more users and connected users of users, lists, networks, members, friends, friends of friends based on privacy settings, permissions, preferences, acceptance of invitations of one or more connected users of user or owner(s) of mobile phone number(s).

8. A method according to claim 1, wherein allowing users to apply privacy settings to each connected, related, selected & identified unique identifier to allow to access user's unique identifier or activity specific one or more dynamic and accessible action links.

9. A method according to claim 1, wherein said privacy settings includes allow each unique identifier of contacts or activity to access each dynamic and accessible action links selected by user or associate with user's unique identifier.

10. A method according to claim 1, wherein said privacy settings includes apply privacy settings to allow one or more categories group(s) of users, selected connection or unique identifiers, networks, friends of friends up to particular number of depths or degrees of separation, except excluded users, users of particular locations, places, selected or auto matched current or selected locations, places, names, keywords, filters, categories, profile data, user attributes, users related to particular one or more actions, activities, transactions, brands, status, events and search query or structured database queries (SQL) resulted set of users from database to access one or more selected dynamic and accessible action links selected by users or associate with user's phone number.

11. A method according to claim 1, wherein said privacy settings includes allow to access one or more selected dynamic and accessible action links selected by user(s) or associate with user's unique identifiers including mobile phone number based on rules, conditions, commands, invitations, requests, permission, privacy settings, preferences.

12. A method according to claim 1, wherein said dynamic & accessible actions links referred to related to one or more objects, applications, user profiles, connections, networks, groups, services, multimedia data, widgets, interfaces, presentations, web pages, web sites, commands, functions, actions, tasks, instructions, lists, databases, attachments, messages, unique identity, workspace, one or more controls including menus, lists, combo box, interface, windows, toolbar, tabs for user selections of one or more options or resources.

13. A method according to claim 1, wherein said dynamic & accessible actions links and/or associate or attach objects, applications, services multimedia data and connectable nodes of the network(s) develops, creates, host, store, manage, processes, updates, upgrades, publish, present & provided by users, Dynamic & Accessible Actions Server(s), service providers, advertisers and 3^{rd} parties developers.

14. A method according to claim 1, wherein said links related to or enables dynamic and accessible user actions, activities, events, tasks, workflow, communication, collaboration, sharing, transactions, functions, selections, interactions, participating activities of owner of unique identifier.

15. A method according to claim 1, wherein displaying dynamic and accessible action links to set of user or determined user based on searching, matching, selecting unique identifiers including phone numbers of connected users of user, membership, contacts, connections, subscriptions, incoming phone numbers of anonymous or connected users, selections of one or more phone numbers or URLs or unique identity & name, sending request or inviting others for approval, search people, find friends from contacts, categories lists, auto match making, wherein auto match making based on user actions, activities, interactions, transactions, events, locations, status, behavior, profile & user data of user and connected or matched users of user, rules, conditions, ranks, preferences including keywords, categories, source, privacy settings and any combination thereof.

16. A method according to claim 1, wherein create categories lists of unique identifiers and associate dynamic & accessible actions links based on privacy settings and preferences.

17. A method according to claim 16, wherein enable to share said one or more categories lists of unique identifiers and/or associate dynamic & accessible actions links with set of users or determined users.

18. The method according to claim 1, wherein the sender or source and receiver each comprise a user, connected users of user, providers, developers, service providers, central server unit, user computer system, digital source, user application, telephone or mobile, smart devices, automated message(s) source, external domains including web sites, applications, services, devices, networks, databases, social networks, sensors, multi Artificial Intelligence Agent(s), translation system, or speech or voice message(s) source(s) and allowing the user to access said system or part of system from one or more communication channels, applications, services, smart devices, networks, social networks, external domains, communication networks, non-social networks, centralized or peer to peer networks, web sites.

19. A method according to claim 1, wherein presenting unique identifier including mobile phone number and activity specific dynamic & accessible action links when user selects unique identifier including mobile phone number, hover on particular contact or unique identifier, before, during and after calling of particular mobile phone number and selecting & auto identifying activities.

20. A method according to claim 1, wherein managing nodes and connections among nodes in a network comprising steps of:
maintaining in a database a plurality of nodes of a social graph, wherein nodes including phone numbers of users, connected users of users, user activities, dynamic and accessible actions associate objects;
maintaining in a database a plurality of connections in the social graph, where each connection represents a connection between two or more nodes in the social graph;
maintaining in a database information about one or more of the nodes, actions, transactions, communications, connections & interactions among nodes;
enable to search, match, select, manually or auto attach or associate or identify dynamic and accessible action links with unique identifier including mobile phone number; and
presenting dynamic and accessible action links with unique identifier including mobile phone number to set of viewing user.

21. A method according to claim 1, wherein enable to auto generating or creating, auto determining, auto searching & matching, auto selecting, auto detecting, auto sensing, auto posting or presenting, auto updating dynamic & accessible actions or dynamic & accessible action links.

22. A method according to claim 1, wherein enable to create and update one or more categories lists of dynamic & accessible actions or dynamic & accessible action links or dynamic & accessible connectable nodes of network(s).

23. A method according to claim 22, wherein said categories list created based on user selection, search & match, suggested & provided by connected & matched users of user, suggested list, auto generated list based on user profiles, user data, user activities, user actions, past responses, interest, list of connected users, installed applications, uploaded by user and presented by 3^{rd} parties developers, service providers and advertisers based on users privacy settings and preferences.

24. The method according to claim 1, wherein said associate data of dynamic & accessible actions comprising reference URL or namespace of each dynamic & accessible actions for identifying and allowing to access dynamic & accessible actions link associate objects, applications, services, media data, people, entities, identities, profile, group, network, page and other objects of network, dynamic & accessible actions related one or more metadata, categories, keywords, sources, providers, details, descriptions, properties, links, attachments, features, upload, created & use date & time, help, identifier & profile(s) of sender & receiver of dynamic & accessible actions, dynamic & accessible actions associate tracking status & status, dynamic & accessible actions associate object related user data and preferences, security policies, authentication information and privacy settings of accessing & sharing dynamic & accessible actions and dynamic & accessible actions associate object(s) related user data.

25. A method according to claim 1, wherein verify and register dynamic & accessible action links and associate reference items or objects.

26. The method according to claim 1, wherein said dynamic & accessible action links and associated or attached reference items or objects provided and host by the central unit, users, connected users of user, 3^{rd} parties developers, service providers and advertisers.

27. The method according to claim 1, wherein storing interactions of between or among user, connected users of user and dynamic & accessible action links and associated or attached reference items or objects.

28. The method according to claim 1 or 24, wherein user can share selective user profiles and user data with connected or related users, central unit, external domains, and service providers based on privacy settings and preferences.

29. The method according to claim 1, wherein said dynamic & accessible action links and associated or attached reference items or objects manage and invoked in an integrated environment.

30. The method according to claim 1, wherein enabling user to take one or more user actions on one or more unique identifiers and/or dynamic & accessible action links and associated or attached reference items or objects wherein said user actions comprising apply privacy settings & presentation settings, search, match, share, filter, sort, order, group, categories, bookmark, attach, detach, add, update, delete, update, upgrades, categories, group, view logs, invitations, sent requests, actions, transactions, events, activities & communications details, report spam, abuse & violation, set tracking status, provide comments & ranks.

31. The method according to claim 1, wherein managing dynamic activities associate dynamic actions related to unique identifier comprising: enabling to manually define, search, match, select, update and present one or more activities or auto match, determine, detect, sense, recognize, identify and present one or more user activities; manually or dynamically or automatically search, match, determine, select, attach said each activity associate dynamic & accessible actions; and dynamically present one or more said dynamic & accessible actions with said each activity.

32. The method according to claim 31, wherein metadata & data associate with activities comprising activity profile, activity type, activity name or label, activity identity & URL, public or private activity type, activity structured or unstructured details, author of activity, actor identity & profile, one or more participants identity & profiles, date & timings, locations, activity associate one or more dynamic & accessible action links and associate referenced one or more applications, services, objects, connectable or connected nodes of network connected in network environment, multimedia data, user actions, dynamic application features, interface, controls, instructions, commands, rules, networks, groups, lists, attachments, messages, connection & profile objects and databases, details of acting on activities including user's and connected users' or participants' interactions, actions, transactions, behavior associate with activity, status of activity, privacy settings, preferences, rules, conditions, categories, keywords associate with activity, similar or alternative activities, similar types of activities related matched data, payment & transaction information, related part of social graph.

33. The method according to claim 31, wherein user or on behalf of user connected users of user, providers, service providers, developers, external domains, central server unit can manually or automatically define, search, match, select, associate, attach, share, participate, manage, maintain, update, present one or more activities.

34. The method according to claim 31, wherein user or on behalf of user connected users of user, providers, service providers, developers, external domains, central server unit can manually or automatically manage, maintain, define, create, search, match, select, filter, attach, detach, update, edit, associate, present, categories, sort, order, rank, associate metadata, profile, and maintain data including monitoring, tracking and storing data related to each entities interactions with said activities, detect, sense, identify, recognize, store, process one or more activities or actions including defined, auto identified or detected or sensed or inferred or recognized, user created, edited, updated, current, prospective, suggested, liked, determined, connected, related, contextual, undefined, excluded, blocked, removed, detached, past, present, future, presented, selected, inferred, transformed, possible in near future activities.

35. The method according to claim 31, wherein monitoring, tracking, storing and maintaining interactions, user actions, transactions, behavior, status of user, connected users of user, dynamic & accessible links with activities.

36. The method according to claim 31, wherein automatically and dynamically search, auto or manually match and determine activity associate dynamic actions based on user's privacy settings, preference, user inputs including details, commands, rules, instructions, selections, user data, user profile, user interacted or participants data and activity type metadata, select, filter, attach, detach, associate, purchase, order customized, select template and select or edit or update or customize from template or tags, select from suggested or auto match list provided by connected users of user including friends, friends of friends, part of social graph, providers, service providers, external domains, and central server unit, one or more dynamic & accessible action links.

37. A method according to claim 1, wherein dynamic & accessible link further comprises one or more associated dynamic & accessible links.

38. A method according to claim 1, wherein unique identifiers associate list of Dynamic & Accessible Actions Links can dynamically adds, updates, removes, changes based on user current location(s) or places, sensors, user actions, activities, behavior, instructions, commands, interactions, transactions, status, senses including voice, touch, vision, detection of user image in video or photo, movement, taste, smell, status, triggering of events, closeness of other mobile phones or smart devices of members of Dynamic Actions Network(s).

39. A method according to claim 1, wherein enable users to subscribe one or more dynamic & accessible action links based on selections of one or more sources, categories, keywords, privacy settings, rules, conditions, auto match making criteria based on preferences, user profile, user data, user actions, activities, transactions, behavior, status, triggering of events, interactions with providers profile, dynamic & accessible action links associate metadata, categories, keywords.

40. A method according to claim 1, wherein one or more unique identifiers related to same entity or different entity and same device & clients or different devices or clients may have associated same set of dynamic & accessible links.

41. A method according to claim 1, wherein presenting set of dynamic & accessible links based on one or more formats and styles including list, visual, menu, tree, inline, tabular, buttons, images, page, highlighted, hover & present, and customize presentations.

42. A method according to claim 1, wherein enable user to hover on dynamic & accessible action links and can select, order, categories, organize, share, remove, attach, detach, provide ranks & comments, view help, profile & metadata, apply privacy settings & preferences, request for support, purchase, upgrade & updates dynamic & accessible action links.

43. A method according to claim 1, wherein Dynamic & Accessible Actions Server can dynamically provide, update, synchronize and publish one or more or list or categories contextual, related useful, advertised, suggested and matched unique identifiers including mobile phone numbers, landline phone numbers, user identities or names, email addresses, web site URLs, categories activities with associated or attached dynamic & accessible action links based on auto math making, reference given by connected or related users of user, user preferences, survey data, user data & profile(s), user actions, activities, transactions, connections, subscriptions, selections, behavior, current location or place, triggering of events, status, interactions, and matching advertisement(s) targeting criteria with user data.

44. A method according to claim 1, wherein enable user to search, match, select, filter, attach, allow and receives one or more unique identifiers and associate dynamic & accessible action links presented, suggested & provided by Dynamic & Accessible Actions Server, providers, external sources, advertisers, users of Dynamic & Accessible Actions Network(s), connected or related or matched users of user.

45. A method according to claim 1, wherein enable user to share, forward, synchronize, refer, submit, publish, provide and present one or more one or more unique identifiers and/or associate dynamic & accessible action links with the permission of related provider and/or owner or source of unique identifiers and dynamic & accessible action links.

46. A method according to claim 1, wherein enable user to post one or more dynamic & accessible action links based on selection from categories list(s) of dynamic & accessible action links, entering name or reference URL of dynamic & accessible action links, select from auto matched list(s) of dynamic & accessible action links, select unique identifiers and select from list of associate dynamic & accessible action links to one or more users of networks and selected or connected or related users of user, subscribers, preference based matched users, travel user's social graph up to particular number of depth or degrees of separations.

47. A method according to claim 1, wherein enable user to attach or associate one or more dynamic & accessible action links via searching, matching, filtering, selecting and attaching or associating one or more dynamic & accessible action links from categories list(s) of dynamic & accessible action links, wherein said one or more selectable categories list(s) dynamic & accessible action links of are presented based on user's search queries, match making preferences, one or more filters including source or providers name, locations, categories, paid or free types, rank and other filter criteria, selecting specific types of dynamic & accessible action links including default or system or Dynamic & Accessible Action Server provided dynamic & accessible action links, provider specific, categories activities specific, purchased or subscribed, dynamic & accessible action links related or connected or related users of user, dynamic & accessible action links suggested by Dynamic & Accessible Action Server, connected users of user, advertisers, providers, 3^{rd} parties or external domains and matched users of network or auto matched dynamic & accessible action links based on user data, profile, privacy settings, preferences, activities, actions, interactions, status, behavior, locations, and transactions, categories list or directories of dynamic & accessible action links, bookmarked dynamic & accessible action links, invited, shared, user created and search result specific dynamic & accessible action links, dynamic & accessible action links related to particular types applications, services, multimedia data types, objects, networks, groups, database, lists.

48. A method according to claim 1, wherein enable user to search, attach, detach, and associated with one or more defined, created, selected, matched, current, auto identified or detected or sensed or recognize, shared, suggested, participated, associated activities and select one or more dynamic & accessible action links

49. A method according to claim 1, wherein enable user to apply privacy settings for each attached or associated and selected dynamic & accessible action link(s) for enabling one or more selected users to allow to access said dynamic & accessible action link(s) and enables them to view & access user's shared contents, communicate, collaborate, share, publish, and participate with user's activities, wherein privacy settings can apply via list of privacy settings selections including allow everyone, allow all networks and friends of friends or members, allow only to friends of friends, allow only to user's connected users or friends, allow only to members of networks, allow only selected networks and/or friends and/or friends of friends and/or members of network(s) and/or selected unique identifiers including unique mobile phone numbers, email addresses, website URLs, one or more types or categories or keyword specific activities related or matched or connected one or more users, one or more selected or all subscribers or bookmarked, selected one or more or part of groups or categories lists or allow only to results of search queries, keywords, categories, conditions, filters, auto matchmaking preferences specific users, friends, friends of friends, members and networks to access said selected dynamic & accessible action links.

50. A method according to claim 1, wherein enable user to individually search, match, filter, select users from list, which are presented based on user selection of types of privacy settings and selection of one or more networks, groups, lists, categories, auto group.

51. A method according to claim 1, wherein enable user to select one or more friends, users of networks, friends of friends, members, lists, unique identifiers for excluding to allow to access one or more said selected dynamic & accessible action links.

52. A method according to claim 1, wherein enable user to invite one or more users including connected or related users of user and selected unique identifiers for acceptance of allowable dynamic & accessible action links by receiving user.

53. A method according to claim 1, wherein enable user to accept requests of one or more other users to allow receiving their dynamic & accessible action links at user's interface.

54. A method according to claim 1, wherein enable user to take one or more user actions on one or more selected or group(s) of unique identifiers including mobile number(s), email addresses, website URLs including search, match, filter, sort, remove, block, attach, detach, categories, share, synchronize associate dynamic & accessible action links and/or associate user data and/or associate profile, update, publish, rank, provide comments & descriptions, bookmark, add or update photos or profile, view information, apply privacy settings for allow limited access to one or more connected users or receivers or subscribers and plurality of dynamic, and customized user or system defined or created user actions.

55. A method according to claim 1, wherein enable user to filter user's social graph and access filtered social graph and to search, match, share, attach, detach, remove, block, access, update and apply privacy settings to user's social graph.

56. A system to enable dynamically displaying dynamic and accessible action links with one or more unique identifiers including unique smart phone or mobile phone number(s) and activities.

57. A system according to claim 56, wherein module is configure to create and update social graphs of network based on list of unique identifier or unique identifiers associate with user devices including unique identifiers associate with user, connected or related users of user, friends, friends of friends.

58. A system according to claim 56, wherein enable user to register user or mobile phone, assign unique identity and Uniform Resource Locator (URL) and maintain and store profile, preferences, privacy settings, each unique identifier & activity associate dynamic & accessible action links and associate applications, services, objects and connected nodes of the network(s) connectable in network environment, payment information, connections among users, wherein connections based on mobile phone contacts, mobile social graph, social network, incoming phone numbers of mobile and unique identifiers associated with mobiles or smart devices.

59. A system according to claim 56, wherein unique identifier includes unique phone number, mobile number, email address, IM credentials, URL, links, namespace, URI, IP address, Unique user name, GUID, location, place, activities, actions, keywords, categories and plurality types of unique identifiers.

60. A system according to claim 56, wherein allow users to search, match, select, manually or auto attach or associate dynamic and accessible action links with one or more searched, matched, selected unique identifiers and activities.

61. A system according to claim 56, wherein search, match, select, manually or auto attach or associate dynamic and accessible action links with one or more searched, matched, selected unique identifiers or activities including unique identifiers or activities of user, connected users of user, lists, networks, members, friends, friends of friends based on privacy settings, permissions, preferences, acceptance of invitations of one or more connected users of user or owner(s) of mobile phone number(s).

62. A system according to claim 56, wherein users, service providers, advertisers are enabled to search, match, select, manually or auto attach or associate dynamic and accessible action links with one or more searched, matched, selected unique identifiers or activities including unique identifiers or activities of one or more users and connected users of users, lists, networks, members, friends, friends of friends based on privacy settings, permissions, preferences, acceptance of invitations of one or more connected users of user or owner(s) of mobile phone number(s).

63. A system according to claim 56, wherein users are adapted to apply privacy settings to each connected, related, selected & identified unique identifier to allow to access user's unique identifier or activity specific one or more dynamic and accessible action links.

64. A system according to claim 56, wherein said privacy settings includes allow each unique identifier of contacts or activity to access each dynamic and accessible action links selected by user or associate with user's unique identifier.

65. A system according to claim 56, wherein said privacy settings includes apply privacy settings to allow one or more categories group(s) of users, selected connection or unique identifiers, networks, friends of friends up to particular number of depths or degrees of separation, except excluded users, users of particular locations, places, selected or auto matched current or selected locations, places, names, keywords, filters, categories, profile data, user attributes, users related to particular one or more actions, activities, transactions, brands, status, events and search query or structured database queries (SQL) resulted set of users from database to access one or more selected dynamic and accessible action links selected by users or associate with user's phone number.

66. A system according to claim 56, wherein said privacy settings includes allow to access one or more selected dynamic and accessible action links selected by user(s) or associate with user's unique identifiers including mobile phone number based on rules, conditions, commands, invitations, requests, permission, privacy settings, preferences.

67. A system according to claim 56, wherein said dynamic & accessible actions links referred to related to one or more objects, applications, user profiles, connections, networks, groups, services, multimedia data, widgets, interfaces, presentations, web pages, web sites, commands, functions, actions, tasks, instructions, lists, databases, attachments, messages, unique identity, workspace, one or more controls including menus, lists, combo box, interface, windows, toolbar, tabs for user selections of one or more options or resources.

68. A system according to claim 56, wherein said dynamic & accessible actions links and/or associate or attach objects, applications, services multimedia data and connectable nodes of the network(s) develops, creates, host, store, manage, processes, updates, upgrades, publish, present & provided by users, Dynamic & Accessible Actions Server(s), service providers, advertisers and 3^{rd} parties developers.

69. A system according to claim 56, wherein said links related to or enables dynamic and accessible user actions, activities, events, tasks, workflow, communication, collaboration, sharing, transactions, functions, selections, interactions, participating activities of owner of unique identifier.

70. A system according to claim 56, wherein presentation module is configure to display dynamic and accessible action links to set of user or determined user based on searching, matching, selecting unique identifiers including phone numbers of connected users of user, membership, contacts, connections, subscriptions, incoming phone numbers of anonymous or connected users, selections of one or more phone numbers or URLs or unique identity & name, sending request or inviting others for approval, search people, find friends from contacts, categories lists, auto match making, wherein auto match making based on user actions, activities, interactions, transactions, events, locations, status, behavior, profile & user data of user and connected or matched users of user, rules, conditions, ranks, preferences including keywords, categories, source, privacy settings and any combination thereof.

71. A system according to claim 56, wherein user is enabled to create categories lists of unique identifiers and associate dynamic & accessible actions links based on privacy settings and preferences.

72. A system according to claim 71, wherein enable user to share said one or more categories lists of unique identifiers and/or associate dynamic & accessible actions links with set of users or determined users.

73. The system according to claim 56, wherein the sender or source and receiver each comprise a user, connected users of user, providers, developers, service providers, central server unit, user computer system, digital source, user application, telephone or mobile, smart devices, automated message(s) source, external domains including web sites, applications, services, devices, networks, databases, social networks, sensors, multi Artificial Intelligence Agent(s), translation system, or speech or voice message(s) source(s) and allowing the user to access said system or part of system from one or more communication channels, applications, services, smart devices, networks, social networks, external domains, communication networks, non-social networks, centralized or peer to peer networks, web sites.

74. A system according to claim 56, wherein a presentation module is configure to present unique identifier including mobile phone number and activity specific dynamic & accessible action links when user selects unique identifier including mobile phone number, hover on particular contact or unique identifier, before, during and after calling of particular mobile phone number and selecting & auto identifying activities.

75. A system according to claim 56, wherein manage nodes and connections among nodes in a network comprises:
a storage medium for maintaining in a database a plurality of nodes of a social graph, wherein nodes including phone numbers of users, connected users of users, user activities, dynamic and accessible actions associate objects;
a storage medium for maintaining in a database a plurality of connections in the social graph, where each connection represents a connection between two or more nodes in the social graph;
a storage medium for maintaining in a database information about one or more of the nodes, actions, transactions, communications, connections & interactions among nodes;
enable to search, match, select, manually or auto attach or associate or identify dynamic and accessible action links with unique identifier including mobile phone number; and
a presentation module is configure to present dynamic and accessible action links with unique identifier including mobile phone number to set of viewing user.

76. A system according to claim 56, wherein enable to auto generate or create, auto determine, auto search & match, auto select, auto detect, auto sense, auto post or present, auto update dynamic & accessible actions or dynamic & accessible action links.

77. A system according to claim 56, wherein enable to create and update one or more categories lists of dynamic & accessible actions or dynamic & accessible action links or dynamic & accessible connectable nodes of network(s).

78. A system according to claim 77, wherein said categories list created based on user selection, search & match, suggested & provided by connected & matched users of user, suggested list, auto generated list based on user profiles, user data, user activities, user actions, past responses, interest, list of connected users, installed applications, uploaded by user and presented by 3^{rd} parties developers, service providers and advertisers based on users privacy settings and preferences.

79. The system according to claim 56, wherein said associate data of dynamic & accessible actions comprises reference URL or namespace of each dynamic & accessible actions for identifying and allowing to access dynamic & accessible actions link associate objects, applications, services, media data, people, entities, identities, profile, group, network, page and other objects of network, dynamic & accessible actions related one or more metadata, categories, keywords, sources, providers, details, descriptions, properties, links, attachments, features, upload, created & use date & time, help, identifier & profile(s) of sender & receiver of dynamic & accessible actions, dynamic & accessible actions associate tracking status & status, dynamic & accessible actions associate object related user data and preferences, security policies, authentication information and privacy settings of accessing & sharing dynamic & accessible actions and dynamic & accessible actions associate object(s) related user data.

80. A system according to claim 56, wherein a module is configure to verify and register dynamic & accessible action links and associate reference items or objects.

81. The system according to claim 56, wherein said dynamic & accessible action links and associated or attached reference items or objects provided and host by the central unit, users, connected users of user, 3^{rd} parties developers, service providers and advertisers.

82. The system according to claim 56, wherein a storage medium for storing interactions of between or among user, connected users of user and dynamic & accessible action links and associated or attached reference items or objects.

83. The system according to claim 56 or 79, wherein user is adapted to share selective user profiles and user data with connected or related users, central unit, external domains, and service providers based on privacy settings and preferences.

84. The system according to claim 56, wherein said dynamic & accessible action links and associated or attached reference items or objects manage and invoked in an integrated environment.

85. The system according to claim 56, wherein enable user to take one or more user actions on one or more unique identifiers and/or dynamic & accessible action links and associated or attached reference items or objects wherein said user actions comprising apply privacy settings & presentation settings, search, match, share, filter, sort, order, group, categories, bookmark, attach, detach, add, update, delete, update, upgrades, categories, group, view logs, invitations, sent requests, actions, transactions, events, activities & communications details, report spam, abuse & violation, set tracking status, provide comments & ranks.

86. The system according to claim 56, wherein a module is configure to manage dynamic activities associate dynamic actions related to unique identifier comprised: enable to manually define, search, match, select, update and present one or more activities or auto match, determine, detect, sense, recognize, identify and present one or more user activities; a module(s) are configure to manually or dynamically or automatically search, match, determine, select, attach said each activity associate dynamic & accessible actions; and a presentation module is configure to dynamically present one or more said dynamic & accessible actions with said each activity.

87. The system according to claim 86, wherein metadata & data associate with activities comprises activity profile, activity type, activity name or label, activity identity & URL, public or private activity type, activity structured or unstructured details, author of activity, actor identity & profile, one or more participants identity & profiles, date & timings, locations, activity associate one or more dynamic & accessible action links and associate referenced one or more applications, services, objects, connectable or connected nodes of network connected in network environment, multimedia data, user actions, dynamic application features, interface, controls, instructions, commands, rules, networks, groups, lists, attachments, messages, connection & profile objects and databases, details of acting on activities including user's and connected users' or participants' interactions, actions, transactions, behavior associate with activity, status of activity, privacy settings, preferences, rules, conditions, categories, keywords associate with activity, similar or alternative activities, similar types of activities related matched data, payment & transaction information, related part of social graph.

88. The system according to claim 86, wherein user or on behalf of user connected users of user, providers, service providers, developers, external domains, central server unit are enabled to manually or automatically define, search, match, select, associate, attach, share, participate, manage, maintain, update, present one or more activities.

89. The system according to claim 86, wherein user or on behalf of user connected users of user, providers, service providers, developers, external domains, central server unit are enabled to manually or automatically manage, maintain, define, create, search, match, select, filter, attach, detach, update, edit, associate, present, categories, sort, order, rank, associate metadata, profile, and maintain data including monitoring, tracking and storing data related to each entities interactions with said activities, detect, sense, identify, recognize, store, process one or more activities or actions including defined, auto identified or detected or sensed or inferred or recognized, user created, edited, updated, current, prospective, suggested, liked, determined, connected, related, contextual, undefined, excluded, blocked, removed, detached, past, present, future, presented, selected, inferred, transformed, possible in near future activities.

90. The system according to claim 86, wherein a module is configure to monitor, track, store and maintain user's, connected users of user's and dynamic & accessible links' interactions, actions, transactions, events, behavior, status with activities.

91. The system according to claim 86, wherein a module is configure to automatically and dynamically search, auto or manually match and determine activity associate dynamic actions based on user's privacy settings, preference, user inputs including details, commands, rules, instructions, selections, user data, user profile, user interacted or participants data and activity type metadata, select, filter, attach, detach, associate, purchase, order customized, select template and select or edit or update or customize from template or tags, select from suggested or auto match list provided by connected users of user including friends, friends of friends, part of social graph, providers, service providers, external domains, and central server unit, one or more dynamic & accessible action links.

92. A system according to claim 56, wherein dynamic & accessible link further comprises one or more associated dynamic & accessible links

93. A system to claim 56, wherein a module is configure to dynamically adds, updates, removes, changes based on user current location(s) or places, sensors, user actions, activities, behavior, instructions, commands, interactions, transactions, status, senses including voice, touch, vision, detection of user image in video or photo, movement, taste, smell, status, triggering of events, closeness of other mobile phones or smart devices of members of Dynamic Actions Network(s) one or more unique identifiers associate list of Dynamic & Accessible Actions Links.

94. A system according to claim 56, wherein users are enable to subscribe one or more dynamic & accessible action links based on selections of one or more sources, categories, keywords, privacy settings, rules, conditions, auto match making criteria based on preferences, user profile, user data, user actions, activities, transactions, behavior, status, triggering of events, interactions with providers profile, dynamic & accessible action links associate metadata, categories, keywords.

95. A system according to claim 56, wherein one or more unique identifiers related to same entity or different entity and same device & clients or different devices or clients may have associated same set of dynamic & accessible links.

96. A system according to claim 56, wherein presenting set of dynamic & accessible links based on one or more formats and styles including list, visual, menu, tree, inline, tabular, buttons, images, page, highlighted, hover & present, and customize presentations.

97. A system according to claim 56, wherein enable user to hover on dynamic & accessible action links and can select, order, categories, organize, share, remove, attach, detach, provide ranks & comments, view help, profile & metadata, apply privacy settings & preferences, request for support, purchase, upgrade & updates dynamic & accessible action links.

98. A system according to claim 56, wherein Dynamic & Accessible Actions Server(s) is configure to dynamically provide, update, synchronize and publish one or more or list or categories contextual, related useful, advertised, suggested and matched unique identifiers including mobile phone numbers, landline phone numbers, user identities or names, email addresses, web site URLs, categories activities with associated or attached dynamic & accessible action links based on auto math making, reference given by connected or related users of user, user preferences, survey data, user data & profile(s), user actions, activities, transactions, connections, subscriptions, selections, behavior, current location or place, triggering of events, status, interactions, and matching advertisement(s) targeting criteria with user data.

99. A system according to claim 56, wherein user is enable to search, match, select, filter, attach, allow and receives one or more unique identifiers and associate dynamic & accessible action links presented, suggested & provided by Dynamic & Accessible Actions Server, providers, external sources, advertisers, users of Dynamic & Accessible Actions Network(s), connected or related or matched users of user.

100. A system according to claim 56, wherein enable user to share, forward, synchronize, refer, submit, publish, provide and present one or more one or more unique identifiers and/or associate dynamic & accessible action links with the permission of related provider and/or owner or source of unique identifiers and dynamic & accessible action links.

101. A system according to claim 56, wherein enable user to post one or more dynamic & accessible action links based on selection from categories list(s) of dynamic & accessible action links, entering name or reference URL of dynamic & accessible action links, select from auto matched list(s) of dynamic & accessible action links, select unique identifiers and select from list of associate dynamic & accessible action links to one or more users of networks and selected or connected or related users of user, subscribers, preference based matched users, travel user's social graph up to particular number of depth or degrees of separations.

102. A system according to claim 56, wherein enable user to attach or associate one or more dynamic & accessible action links via searching, matching, filtering, selecting and attaching or associating one or more dynamic & accessible action links from categories list(s) of dynamic & accessible action links, wherein said one or more selectable categories list(s) dynamic & accessible action links of are presented based on user's search queries, match making preferences, one or more filters including source or providers name, locations, categories, paid or free types, rank and other filter criteria, selecting specific types of dynamic & accessible action links including default or system or Dynamic & Accessible Action Server provided dynamic & accessible action links, provider specific, categories activities specific, purchased or subscribed, dynamic & accessible action links related or connected or related users of user, dynamic & accessible action links suggested by Dynamic & Accessible Action Server, connected users of user, advertisers, providers, 3^{rd} parties or external domains and matched users of network or auto matched dynamic & accessible action links based on user data, profile, privacy settings, preferences, activities, actions, interactions, status, behavior, locations, and transactions, categories list or directories of dynamic & accessible action links, bookmarked dynamic & accessible action links, invited, shared, user created and search result specific dynamic & accessible action links, dynamic & accessible action links related to particular types applications, services, multimedia data types, objects, networks, groups, database, lists.

103. A system according to claim 56, wherein enable user to search, attach, detach, and associated with one or more defined, created, selected, matched, current, auto identified or detected or sensed or recognize, shared, suggested, participated, associated activities and select one or more dynamic & accessible action links

104. A system according to claim 56, wherein enable user to apply privacy settings for each attached or associated and selected dynamic & accessible action link(s) for enabling one or more selected users to allow to access said dynamic & accessible action link(s) and enables them to view & access user's shared contents, communicate, collaborate, share, publish, and participate with user's activities, wherein privacy settings can apply via list of privacy settings selections including allow everyone, allow all networks and friends of friends or members, allow only to friends of friends, allow only to user's connected users or friends, allow only to members of networks, allow only selected networks and/or friends and/or friends of friends and/or members of network(s) and/or selected unique identifiers including unique mobile phone numbers, email addresses, website URLs, one or more types or categories or keyword specific activities related or matched or connected one or more users, one or more selected or all subscribers or bookmarked, selected one or more or part of groups or categories lists or allow only to results of search queries, keywords, categories, conditions, filters, auto matchmaking preferences specific users, friends, friends of friends, members and networks to access said selected dynamic & accessible action links.

105. A system according to claim 56, wherein enable user to individually search, match, filter, select users from list, which are presented based on user selection of types of privacy settings and selection of one or more networks, groups, lists, categories, auto group.

106. A system according to claim 56, wherein enable user to select one or more friends, users of networks, friends of friends, members, lists, unique identifiers for excluding to allow to access one or more said selected dynamic & accessible action links.

107. A system according to claim 56, wherein enable user to invite one or more users including connected or related users of user and selected unique identifiers for acceptance of allowable dynamic & accessible action links by receiving user.

108. A system according to claim 56, wherein enable user to accept requests of one or more other users to allow receiving their dynamic & accessible action links at user's interface.

109. A system to claim 56, wherein enable user to take one or more user actions on one or more selected or group(s) of unique identifiers including mobile number(s), email addresses, website URLs including search, match, filter, sort, remove, block, attach, detach, categories, share, synchronize associate dynamic & accessible action links and/or associate user data and/or associate profile, update, publish, rank, provide comments & descriptions, bookmark, add or update photos or profile, view information, apply privacy settings for allow limited access to one or more connected users or receivers or subscribers and plurality of dynamic and customized user or system defined or created user actions.

110. A system according to claim 56, wherein enable user to filter user's social graph and access filtered social graph and to search, match, share, attach, detach, remove, block, access, update and apply privacy settings to user's social graph.
